(19) United States
(12) Patent Application Publication
(10) Pub. No.: US 2011/0302032 A1
(43) Pub. Date: Dec. 8, 2011

(54) CONTENT RECOMMENDATION DEVICE AND CONTENT RECOMMENDATION METHOD

(76) Inventors: Kazuo ISHII, Tokyo (JP); Nozomu IKEDA, Tokyo (JP); Yoshikazu TAKAHASHI, Saitama (JP); Masaaki ISOZAKI, Kanagawa (JP); Shoji SHIOMOTO, Tokyo (JP); Wataru ONOGI, Kanagawa (JP); Katsu SAITO, Saitama (JP); Masaaki KOYANAGI, Tokyo (JP)

(21) Appl. No.: 13/150,891

(22) Filed: Jun. 1, 2011

(30) Foreign Application Priority Data
Jun. 8, 2010 (JP) P2010-131014

(51) Int. Cl. G06Q 30/00; G06F 3/00

(52) U.S. Cl. 705/14.53; 715/739

(57) ABSTRACT

A content recommendation device includes: a use information storage section storing types of information related to use as information related to use of content by a user; a recommended content deciding section deciding content to be recommended to the user in accordance with each of the types of information related to use as a recommended content, and deciding types of recommended content items corresponding to the types of information related to use; a switching rule storage section storing a switching rule setting a period for switching the type of the recommended content as a rule set by a regional manager who is in charge of selling content in a specific region; a selection section selecting one type of the recommended content among the types of recommended content items when a recommended content suggestion request is generated from a terminal of the user residing in the specific region, and sequentially selecting different types of content after the period set by the switching rule; and a recommended information providing section providing information representing the recommended content selected by the selection section for the terminal of the user.

### FIELD

The present disclosure relates to a data processing technique, and particularly, to a technique of recommending content such as a videogame to a user.

### BACKGROUND

Up till now, in order to recommend content to a user, collaborative filtering based on user behavior information or preference information has been adopted. For example, a user group (cluster) having similar behavior and preferences is set by clustering a plurality of users on the basis of a profile representing user characteristics. Then, in regards to a user who becomes a recommendation partner popular content in the cluster where the user belongs is recommended to the user as recommended content.

### SUMMARY

When the recommended content of the user is decided on the basis of user behavior information or preference information, the recommended content is difficult to change when there is no change in the user's behavior or preference. Accordingly, the present inventor considered that the recommended content did not sufficiently change every day and new information was difficult to suggest to the user.

Thus, it is desirable to provide a technique of realizing a content recommendation in which the recommended content abundantly changes.

An embodiment of the present disclosure is directed to a content recommendation device including: a use information storage section which stores a plurality of types of information related to use as information related to use of content by a user; a recommended content deciding section which decides content to be recommended to the user in accordance with each of the plurality of types of information related to use as recommended content, and decides a plurality of types of recommended content items corresponding to the plurality of types of information related to use; a switching rule storage section which stores a switching rule setting a period for switching the type of the recommended content as a rule set by a regional manager who is in charge of selling content in a specific region; a selection section which selects one type of the recommended content among the plurality of types of recommended content items when a recommended content suggestion request is generated from a terminal of the user residing in the specific region, and sequentially selects different types of content after the period set by the switching rule; and a recommended information providing section which provides information representing the recommended content selected by the selection section for the terminal of the user.

Another embodiment of the present disclosure is directed to a content recommendation method of allowing a computer to execute: deciding content to be recommended to a user in accordance with a plurality of types of information related to use which is information related to use of content by the user as a recommended content and deciding a plurality of types of recommended content items corresponding to the plurality of types of information related to use; selecting one type of the recommended content among the plurality of types of recommended content items when a recommended content suggestion request is generated from a terminal of a user residing a specific region and sequentially selecting a different type of the recommended content after a period for switching the type of the recommended content set by a regional manager who is in charge of selling content in the specific region; and providing information representing the recommended content selected in the selecting of one type of the recommended content for the terminal of the user.

Furthermore, even when the combination of the above-described constituents and the embodiment of the present disclosure are modified through a device, a method, a system, a program, a recording medium storing a program, and the like, those modifications are also included in the technical scope of the present disclosure.

According to the embodiments of the present disclosure, it is easy to realize the content recommendation in which the recommended content abundantly changes.

### BRIEF DESCRIPTION OF THE DRAWINGS

FIG. 1 is a diagram illustrating a configuration of a recommended information providing system of a first embodiment.

FIG. 2 is a diagram illustrating an external configuration of a content reproduction device of FIG. 1.

FIG. 3 is a diagram illustrating a configuration of an internal circuit of a videogames machine of FIG. 2.

FIG. 4 is a diagram illustrating a configuration of an internal circuit of the content recommendation device of FIG. 1.

FIG. 5 is a diagram illustrating an outline of a process of deciding content recommended to a user in the content recommendation device of FIG. 1.

FIG. 6 is a diagram illustrating an outline of a process of deciding the content recommended to the user in the content recommendation device of FIG. 1.

FIG. 7 is a block diagram illustrating a functional configuration of the content recommendation device of FIG. 1.

FIG. 8 is a diagram illustrating an example of a short-period BF matrix.

FIG. 9 is a diagram illustrating an example of the short-period BF matrix which has reduced dimensions.

FIG. 10 is a diagram illustrating an example of the short-period BF matrix which has reduced dimensions.

FIG. 11 is a diagram illustrating a display example of recommended information on a menu screen.

FIG. 12 is a diagram illustrating a display example of a content detail screen in an on-line store.

FIG. 13 is a flowchart illustrating an operation of the content recommendation device.

FIG. 14 is a diagram illustrating a setting example of weighting a cluster set.

FIG. 15 is a diagram illustrating a configuration of a recommended information providing system of a second embodiment.

FIG. 16 is a block diagram illustrating a functional configuration of a content recommendation device of FIG. 15.

FIG. 17 is a diagram illustrating a configuration example of data stored in a recommended information storing section.

FIG. 18 is a diagram schematically illustrating region layout information.

FIG. 19 is a diagram illustrating an example of a selection convention of a recommended title.

FIG. 20 is a schematic diagram illustrating a procedure of setting recommended information in the content recommendation device.

FIG. 21 is a flowchart illustrating an operation of the content recommendation device.

### DETAILED DESCRIPTION

First, the outline of the present disclosure will be described ahead of the description of the embodiment of the present disclosure.

Currently, in various on-line sites, recommended content is suggested for a user accessing the sites. In order to stimulate user buying inclination by suggesting the recommended content, it is necessary to select and recommend content which is expected to increase the user's satisfaction degree when using the content. In other words, it is necessary to improve the precision of the recommended content. Further, when the content items recommended daily are not sufficiently updated, it is difficult to supply new information to the user and to stimulate the user's buying inclination. Accordingly, it is desirable to suggest information having various recommended content items with a variety of change.

Hereinafter, in the first embodiment, a technique is provided which improves the precision of the recommended content by taking into account the effectiveness in the user clustering for collaborative filtering and deciding the recommended content. Further, in the second embodiment, a technique is provided which suggests various recommended content items to the user by switching a recommended content item to be suggested to the user in accordance with a business rule from various recommended content items decided on the basis of various indexes.

In the embodiments, “content” manly indicates one videogame title. That is, content and the videogame title have the same meaning unless there is a particular reason. Furthermore, the technical application scope suggested in the specification is not limited to the videogame, but may, of course, include various content items recommended to the user such as music content, video content, and various items and goods which may be sold to the user.

### First Embodiment

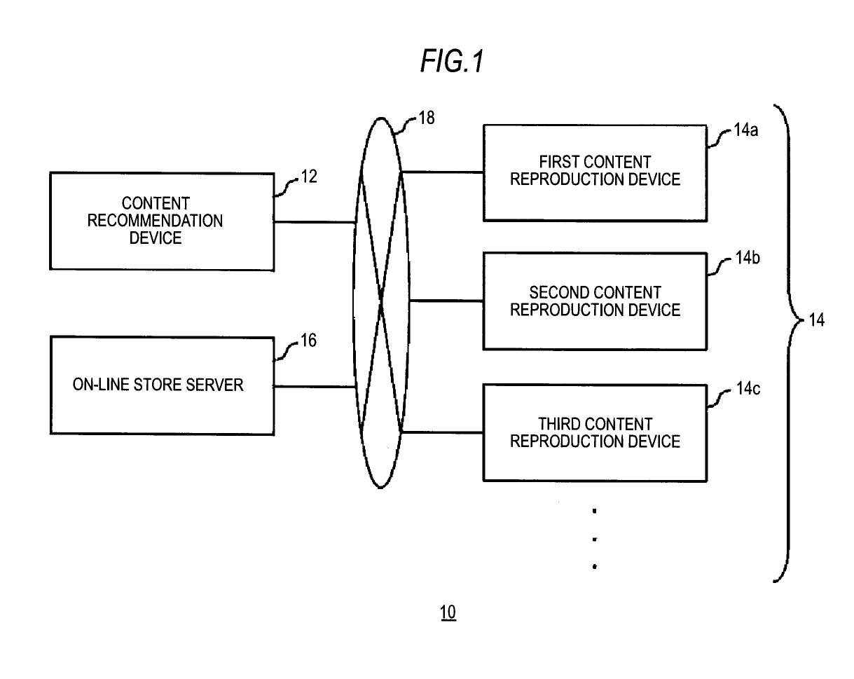

FIG. 1 illustrates a configuration of a recommended information providing system of a first embodiment. A recommended information providing system 10 includes a first content reproduction device 14a, a second content reproduction device 14b, a third content reproduction device 14c, and the like which are generally called a content reproduction device 14, a content recommendation device 12, and an on-line store server 16. The respective devices of FIG. 1 are connected to each other via a communication network 18 including existing communication methods such as a LAN, a WAN, and the Internet.

The content reproduction device 14 is an information processing device which reproduces electronic content. For example, the content reproduction device may be a stationary videogames machine operated by the user, a portable videogames machine, or a general PC. The content recommendation device 12 is a server computer which supplies information of content recommended to the user to the content reproduction device 14. The on-line store server 16 is a server computer which opens content sales site on the internet, and supplies screen data (for example, data of a webpage) of the sales site to the content recommendation device 12.

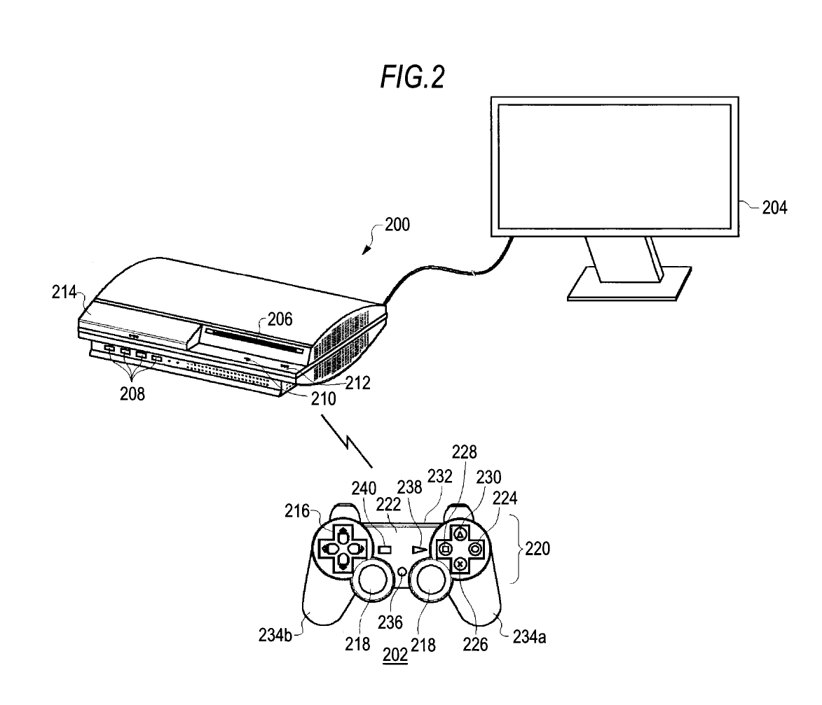

FIG. 2 illustrates an external configuration of the content reproduction device 14 of FIG. 1. Here, a stationary videogames machine 200 is shown as an example of the content reproduction device 14. The videogames machine 200 is connected to a controller 202 and a television monitor 204. The videogames machine 200 has functions of executing various videogames, writing or editing e-mails, reading a webpage, reproducing a movie or music, and the like. The controller 202 is wirelessly connected to the videogames machine 200. The television monitor 204 is connected to the videogames machine 200 to display videogame content, a webpage, a movie, or the like and output sound thereof.

### [Outline of Videogames Machine]

The videogames machine 200 includes a disc insertion slot 206 corresponding to an optical disc having a diameter of 12 cm, a USB connection terminal 208, or the like. The disc insertion slot 206 is configured to load a BD (Blu-ray Disc (trademark or registered trademark)) or an optical disc such as a DVD-ROM or a CD-ROM therein. A touch sensor 210 is a sensor used for taking out a disc, and a touch sensor 212 is a sensor for turning a power supply on or off. Further, although not shown in the drawings, the rear surface side of the videogames machine 200 is provided with a power supply switch, an audio and video output terminal, an optical digital output terminal, an AC power input terminal, a LAN port, an HDMI terminal, and the like. In addition, the videogames machine may further include an IEEE1394 terminal to communicate with IEEE1394.

The videogames machine 200 also includes a multimedia slot. A multimedia slot casing 214 includes a cover member. Although not shown in the drawings, the multimedia slot is configured to be exposed when the multimedia slot casing 214 is opened.

The videogames machine 200 is configured to execute an application program for videogames, an e-mails, or a web browser, and executes various processes for executing a videogame, writing, editing, and receiving the e-mails, and reading the webpages and the like in accordance with the command from the user through the controller 202. The application program may be arbitrarily read from various recording media such as a semiconductor memory, a hard disc drive, or an optical disc such as a CD-ROM, a DVD-ROM, and a BD or may be downloaded from various transmission media such as a LAN and a CATV line.

Furthermore, the videogames machine 200 may not only execute videogames, write, edit, and receive e-mails, or read webpages or the like based on the application program, but also reproduce (decode), for example, video and audio data such as a movie recorded on a DVD and a BD or audio data recorded on a CD. The videogames machine 200 may be operated on the basis of various application programs. Furthermore, the driver program for reproducing the DVD or the BD is recorded in, for example, a hard disc drive 334 embedded in the videogames machine 200.

### [Outline of Controller]

The controller 202 is driven by a battery (not shown), and includes a plurality of buttons or keys used for inputting an operation input executing a videogame or the like. When the user operates a button or a key of the controller 202, the operation input is transmitted to the videogames machine 200 in a wired or wireless manner.

The controller 202 includes a direction key 216, an analog stick 218, and four types of operation buttons 220. The direction key 216, the analog stick 218, and the operation buttons 220 are input sections which are provided in a front casing 222. The four types of buttons 224, 226, 228, and 230 are respectively marked with different figures and colors in order to distinguish them from each other. That is, the circular button 224 marked with a red circle, the cross button 226 is marked with a blue cross, the square button 228 is marked with a violet square, and the triangular button 230 is marked with a green triangle. Although not shown in the drawings, a rear casing 232 of the controller 202 is provided with a plurality of LEDs.

The user operates the controller 202 while gripping a left grip portion 234b with the left hand and gripping a right grip portion 234a with the right hand. The direction key 216, the analog stick 218, and the operation buttons 220 are provided on the front casing 222 to be operated while the user grips the left grip portion 234b and the right grip portion 234a.

The front casing 222 is also provided with an LED fitted button 236. The LED fitted button 236 is used as, for example, a button displaying a menu screen on the videogames machine 200. Further, the LED fitted button 236 has a function of informing the user that an e-mail has been received or if a battery of the controller 202 is charged in accordance with the emission state of the LED. For example, the LED turns red when the battery is being charged, turns green when the battery is completely charged, and flashes red when the remaining battery charge is low.

The direction key 216 is provided with direction keys indicating the directions of “up”, “down”, “left”, and “right” and operated by the user to move, for example, a videogame character of a videogame up, down, left, and right on a screen, to move a character input cursor up, down, left, and right on an e-mail writing screen, to scroll a page when reading a webpage, or to move a cursor on the screen up, down, left, and right. Furthermore, the direction keys indicating the directions of “up”, “down”, “left”, and “right” are used not only to indicate the up, down, left, and right directions, but also indicate the oblique direction. For example, when the direction keys indicating the directions of “up” and “right” are simultaneously pressed, the user may direct the videogames machine 200 toward the oblique right upwards direction. The same applies to the other direction keys. For example, when the direction keys for indicating the directions of “down” and “left” are simultaneously pressed, the user may direct the videogames machine 200 toward the oblique left downwards direction.

The operation buttons 220 respectively have different functions allocated by the application program. For example, the triangular button 230 has a function of displaying a menu, the cross button 226 has a function of canceling the selected item, the circular button 224 has a function of deciding the selected item, and the square button 228 has a function of displaying or not displaying, for example, a table of contents.

The analog stick 218 includes a rotation portion which is tiltable in an arbitrary direction about a rotation support point of an operation shaft and a variable analog value output section which outputs a variable analog value in accordance with the operation of the rotation portion. The rotation portion is attached to the front end side of the operation shaft so that the rotation portion returns to a neutral position due to an elastic member. The rotation portion is kept at a reference position in an upright state (without any inclination) when the tilting operation is not performed by the user. The variable analog value output section includes a variable resistor element and the like. The resistance of the variable resistor element changes in accordance with the operation of the rotation portion. When the rotation portion of the analog stick 218 is tilted, the controller 202 detects an inclined amount with respect to the reference position and a coordinate value on the XY coordinate along the inclined direction, and transmits the coordinate value as an operation output signal to the videogames machine 200.

Further the controller 202 includes a select button 240, a start button 238, and the like. The start button 238 is a button which is used to start a videogame, display an e-mail screen, or start or pause a movie or music by the user. The select button 240 is a button which is used to instruct the user to select the menu screen displayed on the television monitor 204 or the like.

The controller 202 includes a vibration generating mechanism which is provided inside each of the left and right grip portions 234a and 234b. The vibration generating mechanism includes, for example, a weight which is eccentric with respect to the rotation shaft of the motor, and vibrates the controller 202 by rotating the weight in the motor. The vibration generating mechanism is operated in accordance with a command from the videogames machine 200. The controller 202 transmits a vibration to the user's hands by operating the vibration generating mechanism.

### [Internal Configuration of Videogames Machine]

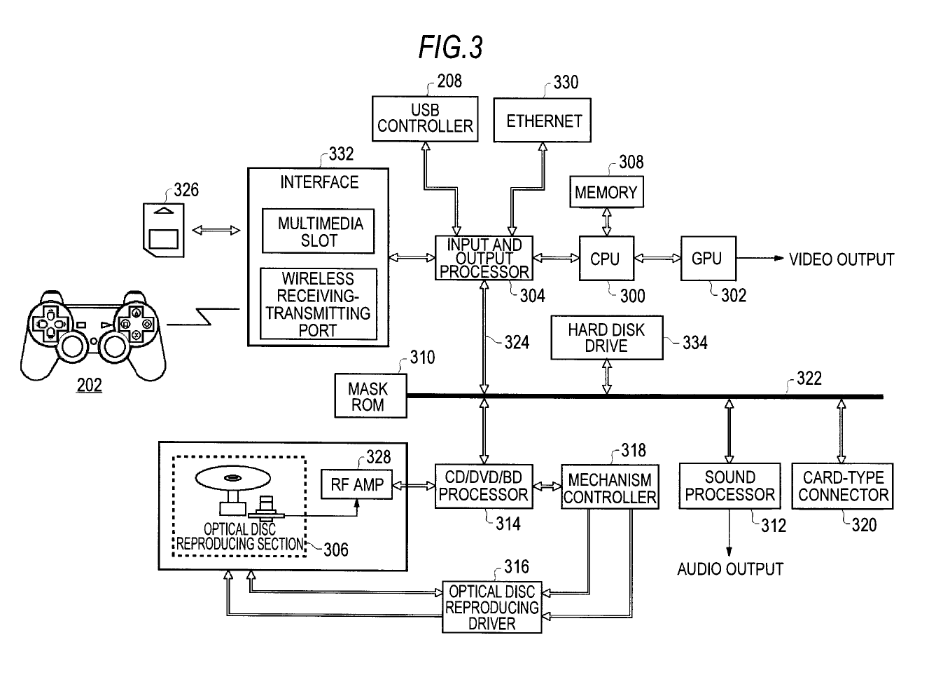

Next, a configuration of the internal circuit of the videogames machine 200 will be described by referring to FIG. 3. The videogames machine 200 basically includes a main CPU 300, a GPU (Graphic Processor Unit) 302, an input and output processor 304, an optical disc reproduction section 306, a main memory 308, a mask ROM 310, and a sound processor 312. The main CPU 300 controls the signal process or the internal constituents on the basis of various programs such as application programs for videogames, e-mail, and a web browser. The GPU 302 executes an image process. The input and output processor 304 executes an interface process between an external device and an internal device or a process of maintaining backward compatibility. The optical disc reproduction section 306 reproduces an application program or an optical disc such as a BD, a DVD, or a CD recording multimedia data. The main memory 308 functions as a buffer temporarily storing data read from the optical disc or a work area of the main CPU 300. The mask ROM 310 mainly stores an operating system program executed by the main CPU 300 or the input and output processor 304. The sound processor 312 processes audio data.

Further, the videogames machine 200 also includes a CD/DVD/BD processor 314, an optical disc reproduction driver 316, a mechanism controller 318, a hard disc drive 334, and a card-type connector (for example, a PC card slot) 320. The CD/DVD/BD processor 314 executes, for example, an error correction process (for example, a CIRC (Cross Interleave Reed-Solomon Coding) process) or a decompression decoding process on a disc reproduction signal read from a CD, a DVD, or a BD by the optical disc reproduction section 306 and amplified in an RF amplifier 328 to reproduce (restore) data recorded in the CD, the DVD, or the BD. The optical disc reproduction driver 316 and the mechanism controller 318 execute a spindle motor rotation control, an optical pickup focus and tracking control, and a disc tray loading control of the optical disc reproduction section 306.

Further, the hard disc drive 334 stores, for example, saved data of a videogame or an application program read by the optical disc reproduction section 306 or stores data such as a picture, a video, and music obtained via the input and output processor 304. The card-type connector 320 is a connection port of, for example, a communication card or an external hard disc drive.

These respective sections are mainly connected to each other via bus lines 322 and 324 or the like. Furthermore, the main CPU 300 and the GPU 302 are connected to each other via an exclusive bus. Further, the main CPU 300 and the input and output processor 304 are connected to each other via an SBUS. The input and output processor 304, the CD/DVD/BD processor 314, the mask ROM 310, the sound processor 312, the card-type connector 320, and the hard disc drive 334 are connected to each other via an SSBUS.

The main CPU 300 controls the entire operation of the videogames machine 200 by executing an operating system program for the main CPU stored in the mask ROM 310. Further, the main CPU 300 reads the operating system program from an optical disc such as a CD, a DVD, or a BD and loads the operating system program in the main memory 308. Further, the main CPU 300 executes various application programs downloaded via a communication network, and controls an operation of executing a videogame, writing and editing an e-mail, reading a webpage, or the like.

The input and output processor 304 sets a videogame or a signal from the controller 202 in accordance with the user operation or controls an input and output of data from a memory card 326 storing content or an e-mail address and a of a website URL by executing the operating system program for the input and output process stored in the mask ROM 310. In addition, the input and output processor 304 also controls the input and output of data of the USB connection terminal 208, Ethernet (for example, a network card) 330, an IEEE1394 terminal (not shown), or a PC card slot (not shown). Further, the input and output processor 304 also executes the input and output of data with respect to the memory card 326 via a PC card slot (not shown). The information from the controller 202 or the memory card is received and transmitted via an interface 332 including a multimedia slot or a wireless receiving and transmitting port.

The GPU 302 has a geometry transfer engine function of executing coordinate conversion or the like and a rendering processor function. The GPU 302 draws an image in accordance with an image drawing command from the main CPU 300 and accommodates the drawn image in a frame buffer (not shown). That is, for example, when various application programs recorded in an optical disc use so-called three dimensional (3D) graphics such as in a videogame, the GPU 302 calculates a coordinate or the like of a polygon forming a three-dimensional object by the geometry calculation process. Further, in terms of the rendering process, the GPU 302 executes a calculation for creating an image obtained by photographing the three-dimensional object through a virtual camera, that is, a calculation related to perspective transformation (a calculation or the like of a coordinate value when the apexes of each polygon forming the three-dimensional object are projected onto a virtual camera screen). The GPU 302 writes the finally obtained image data in the frame buffer. Then, the GPU 302 outputs a video signal corresponding to the created image.

The sound processor 312 has an ADPCM (Adaptive Differential Pulse Code Modulation) decoding function, an audio signal reproducing function, a signal conversion function, and the like. The ADPCM decoding function indicates a function of reproducing and outputting an audio signal such as a sound effect by reading waveform data stored in a sound buffer (not shown) attached to the inside or the outside of the sound processor 312. The signal conversion function serves as a so-called sampling sound source of generating an audio signal such as a sound effect or a music sound from waveform data stored in the sound buffer.

In the videogames machine 200 with the above-described configuration, for example, when power is turned on, an operating system program for the main CPU 300 and the input and output processor 304 is read from the mask ROM 310. The main CPU 300 and the input and output processor 304 execute the operating system programs respectively corresponding thereto. Accordingly, the main CPU 300 generally controls the respective sections of the videogames machine 200. Further, the input and output processor 304 controls the input and output of a signal between the controller 202, the memory card 326, and the like. Further, the main CPU 300 first executes an initialization process such as an operation check when the operating system program starts. Subsequently, the main CPU 300 reads an application program of a videogame and the like recorded on the optical disc by controlling the optical disc reproduction section 306, and executes the videogame application program by loading it on the main memory 308. When the videogame application program is executed, the main CPU 300 controls the GPU 302 or the sound processor 312 in accordance with a user command received from the controller 202 via the input and output processor 304, and controls a display of an image or a generation of a sound effect and a music sound.

For example, when a movie or the like recorded in an optical disc is reproduced, the main CPU 300 controls the GPU 302 or the sound processor 312 in accordance with the command received from the controller 202 via the input and output processor 304, and controls the display of the movie reproduced from the optical disc or the generation of the sound effect, the music or the like.

When it is necessary to transmit data to the external device, the main CPU 300 transmits the data to the communication network 18 via the input and output processor 304 and Ethernet (for example, a network card) 330. Further, the main CPU 300 receives the data transmitted from the external device via the Ethernet 330 and the input and output processor 304, and executes an appropriate data process.

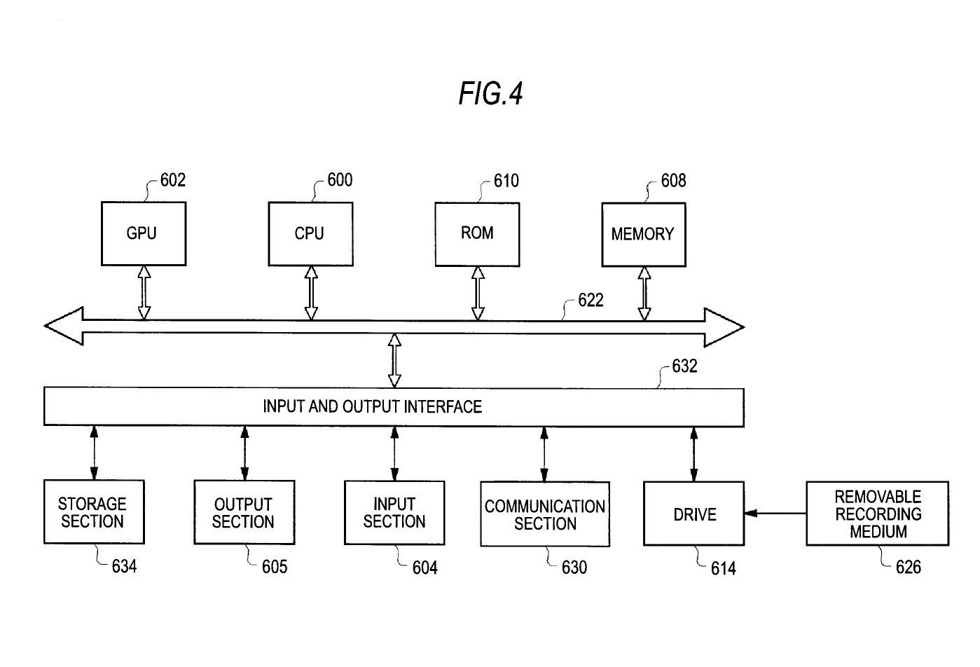

FIG. 4 is a diagram illustrating a configuration of the internal circuit of the content recommendation device 12 of FIG. 1. Furthermore, as described above, the content reproduction device 14 may be a PC, and in this case, the internal circuit of the content reproduction device 14 has the same configuration. The content recommendation device 12 basically includes a main CPU 600, a graphic processor unit (GPU) 602, an input section 604, an output section 605, a drive 614, a main memory 608, and a ROM 610. The main CPU 600 controls a signal process or an internal constituent on the basis of various programs such as application programs of a videogame, an e-mail, or a web browser. The GPU 602 executes an image process.

These sections are alternately connected to each other via a bus line 622 and the like. Furthermore, an input and output interface is connected to the bus line 622. The input and output interface is connected with a storage section 634 including a hard disc or a nonvolatile memory, an output section 605 including a display or a speaker, an input section 604 including a keyboard, a mouse, or a microphone, a communication section 630 including an interface such as a USB or an IEEE1394 or a network interface such as a wired LAN or a wireless LAN, and a drive 614 driving a removable recording medium 626 such as a magnetic disc, an optical disc, or a semiconductor memory.

The main CPU 600 controls the entire operation of the device by executing the operating system program recorded in the hard disc or the like. Further, the main CPU 600 reads the operating system from an optical disc such as a CD, a DVD, or a BD and loads it on the main memory 608. The main CPU 600 executes various application programs downloaded via the communication network, and controls an operation of executing a videogame, writing and editing an e-mail, reading a webpage, or the like.

Further, the main CPU 600 controls a signal obtained from the input section 604 in accordance with the user operation via the input and output interface 632, the input and output of data from the removable recording medium 626 or the like, and the input and output of data in the communication section 630 or the drive 614.

The GPU 602 has a geometry transfer engine function of executing coordinate conversion or the like and a rendering processor function. The GPU 602 draws an image in accordance with an image drawing command from the main CPU 600 and accommodates the drawn image in a frame buffer (not shown). That is, for example, when various application programs recorded in an optical disc use so-called three dimensional (3D) graphics as in a videogame, the GPU 602 calculates a coordinate or the like of a polygon forming a three-dimensional object by the geometry calculation process. Further, in terms of the rendering process, the GPU 602 executes a calculation for creating an image obtained by photographing the three-dimensional object through a virtual camera, that is, a calculation related to perspective transformation (a calculation or the like of a coordinate value when the apexes of each polygon forming the three-dimensional object are projected onto a virtual camera screen). The GPU 602 writes the finally obtained image data in the frame buffer. Then, the GPU 602 outputs a video signal corresponding to the created image.

In the PC with the above-described configuration, for example, when power is turned on, the PC executes an initialization process by reading BIOS from the nonvolatile memory which is a part of the storage section 634, and reads an operating system program. Then, the main CPU 600 executes the operating system program. Accordingly, the main CPU 600 generally controls the respective sections of the PC.

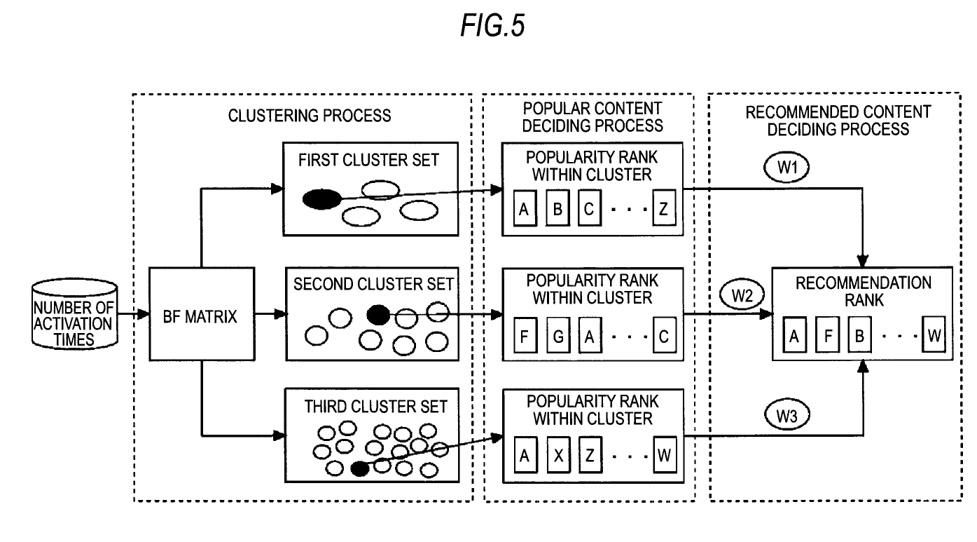

FIG. 5 illustrates an outline of a process of deciding content to be recommended to the user in the content recommendation device 12 of FIG. 1. In the same drawing, a process of deciding a recommended content to a user to be supplied with recommended information (hereinafter, referred to as “a user of a recommendation object”) will be described by one set of input data. The input data in this example indicates information (hereinafter, simply referred to as “activation times”) representing the number of activation times of each content item in the content reproduction device 14.

First, as a clustering process, there is provided a BF (Boot Frequency) matrix which is a matrix table having a plurality of users and a plurality of content items arranged along the horizontal and vertical axes and is set by setting the number of activation times of the content of the user in each cell. Then, the plurality of users is clustered as any one of four clusters, and a first cluster set including the four clusters is created. In the same manner, each user is clustered as any one of eight clusters, and a second cluster set including the eight clusters is created. Further, each user is clustered as any one of sixteen clusters, and a third cluster set including the sixteen clusters is created. That is, a plurality of types of cluster sets of which the numbers of the clusters included therein are different is created.

Next, as a popular content deciding process, a popularity rank is decided within a cluster (hereinafter, referred to as a “user cluster”) where the user of the recommendation object belongs in each of the first to third cluster sets. Then, as a recommended content deciding process, the popularity rank in the user cluster within the first to third cluster sets is counted by adding the larger weightings (W1 to W3) thereto as the clustering in the cluster set becomes more effective, and the recommendation rank of the content with respect to the user of the recommendation object is finally decided.

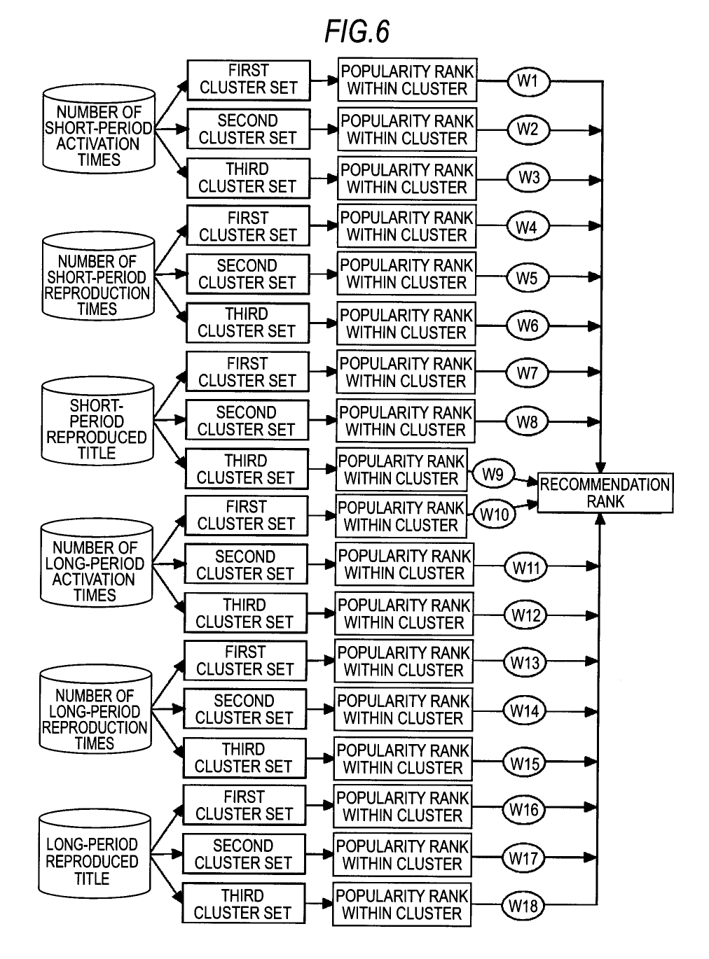

FIG. 6 illustrates an outline of a process of deciding content to be recommended to the user in the content recommendation device 12 of FIG. 1. In the same drawing, the recommended content deciding process of the first embodiment is shown, and the cluster deciding process, the popular content deciding process, and the recommended content deciding process of FIG. 5 are performed on each of a plurality of types of input data. Furthermore, the input data of the first embodiment includes six types obtained by a combination of three types of input data and two types of counting periods. The three types of input data include (1) the number of activation times, (2) information representing the period in which each content item is reproduced by the content reproduction device 14 (hereinafter, simply referred to as a “reproduction period”), and (3) information representing the content items reproduced once or more by the content reproduction device 14 (hereinafter, simply referred to as a “reproduced title”), in other words, the content items having been used at least once. Further, the counting period includes (1) a short period, for example, three months and (2) a long period, for example, one year.

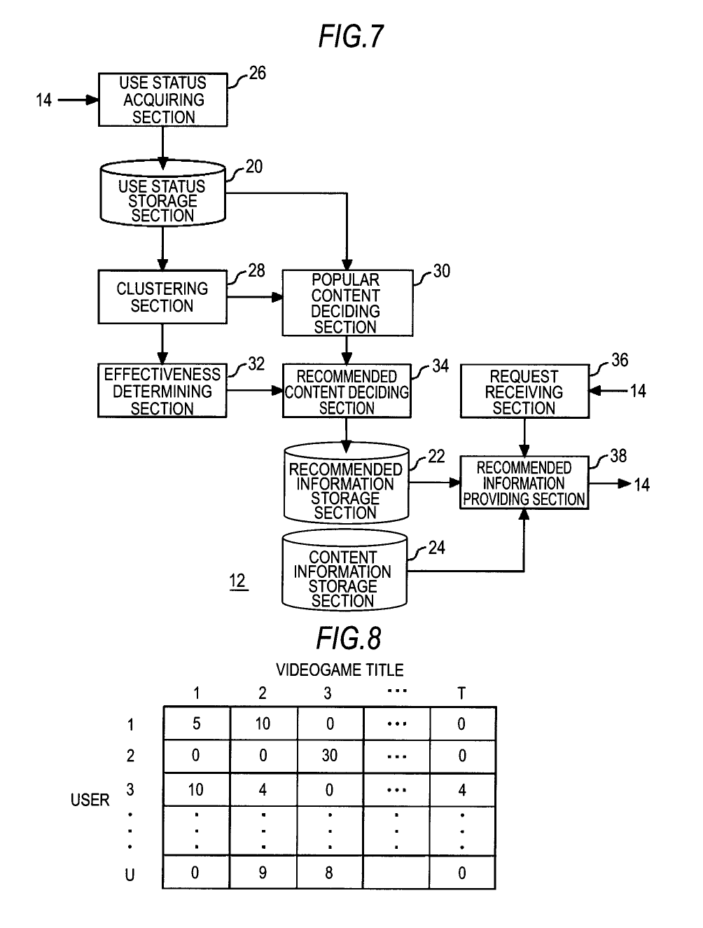

FIG. 7 is a block diagram illustrating a functional configuration of the content recommendation device 12 of FIG. 1. The content recommendation device 12 includes a use status storage section 20, a recommended information storage section 22, and a content information storage section 24 which are storage areas for storing various data therein. Furthermore, the content recommendation device 12 includes a use status acquiring section 26, a clustering section 28, a popular content deciding section 30, an effectiveness determining section 32, a recommended content deciding section 34, a request receiving section 36, and a recommended information providing section 38 which are functional blocks for executing various data processes.

The respective blocks in the block diagram of the specification may be realized by a CPU or a memory of a computer, an element or an electronic circuit including an HDD, and a mechanical device in terms of hardware, and be realized by a computer program in terms of software. However, in the block diagram, the functional blocks realized by the combination thereof is shown. Accordingly, it is understood by persons skilled in the art that the functional blocks are realized in various embodiments by the combination of hardware and software. For example, a program module of each functional block of FIG. 7 may be stored in the removable recording medium 626 of FIG. 4 and be installed in the storage section 634. Further, each functional block for the data process of FIG. 7 may be executed by the main CPU 600 or the GPU 602 while being appropriately loaded on the main memory 608.

The use status storage section 20 stores information representing the use status of the content by the plurality of users. The use status storage section 20 stores a use status of each content item correlated to each of the plurality of users, where the use status specifically includes six types of data, that is, the number of short-period and long-period activation times, the short-period and long-period reproduction periods, and the short-period and long-period reproduced titles shown in FIG. 6. Furthermore, the use status of the content by the user is the same as the use status of the content in the content reproduction device 14, and the following process for the user may be established even when it is replaced by the process for the content reproduction device 14.

The recommended information storage section 22 stores information related to content to be recommended to the user decided by the recommended content deciding section 34. The recommended information storage section 22 stores an ID of content to be recommended to each of the IDs of the plurality of users so as to be correlated thereto. The recommended information storage section 22 may store the ID of the high rank content of the recommended rank with respect to each user.

The content information storage section 24 stores a variety of information for each of the plurality of content items. In the first embodiment, the content information storage section 24 stores at least data of a title (a videogame title), a provider name, and a thumbnail image correlated to the ID of each content item.

The use status acquiring section 26 periodically collects information representing the use status of the content by the user from the content reproduction device 14 and stores it in the use status storage section 20. For example, an application program periodically reporting the use status of the content of the device itself to the content recommendation device 12 may be installed in the content reproduction device 14. The application program may be periodically activated, and the content reproduction device 14 may transmit the number of the short-period and long-period activation times, the short-period and long-period reproduction times, and the short-period and long-period reproduced titles to the use status acquiring section 26 via the Ethernet 330. The use status acquiring section 26 may acquire six types of use status data transmitted from the content reproduction device 14 via the communication section 630.

The clustering section 28 executes the clustering process of FIG. 5 and creates a matrix table corresponding to the respective use statuses by referring to the six types of use status data stored in the use status storage section 20. Specifically, the plurality of users and the plurality of content items are arranged along the vertical and horizontal axes, and a short-period BF matrix having the number of short-period activation times set for each cell and a long-period BF matrix having the number of long-period activation times set for each cell are created. Further, a short-period PT (Play Time) matrix having a short-period reproduction period set for each cell and a long-period PT matrix having a long-period reproduction period set for each cell are created. Further, a short-period UT (User Title) matrix having a short-period reproduced title set for each cell and a long-period UT matrix having a long-period reproduced title set for each cell are created.

FIG. 8 illustrates an example of the short-period BF matrix. The users 1 to U are arranged along the vertical axis, and the videogame titles 1 to T are arranged in the horizontal axis. For example, the number of users may be in the order of from several tens of thousands to several hundreds of thousands, and the number of videogame titles may be in the order of several thousands. The number of the short-period activation times is set for each cell of the same drawing. Here, for example, the drawing shows that the user 1 has activated the videogame title 1 five times and activated the videogame title 2 ten times in the recent three months. Furthermore, in each cell of the short-period UT matrix and the long-period UT matrix, “1” may be set when the content has been reproduced at least once and “0” may be set when the content is not reproduced.

Here, each of the plurality of videogame titles is classified in advance as any one of the four clusters corresponding to the first cluster set on the basis of the feature related to each videogame title. Further, each of the plurality of videogame titles is classified in advance as any one of the eight clusters corresponding to the second cluster set. Furthermore, each of the plurality of videogame titles is classified in advance as any one of the sixteen clusters corresponding to the third cluster set. For example, each of the plurality of videogame titles may be classified on the basis of references such as videogame titles of similar videogame content items, videogame titles of the similar genre, videogame titles having similar release dates, or the like.

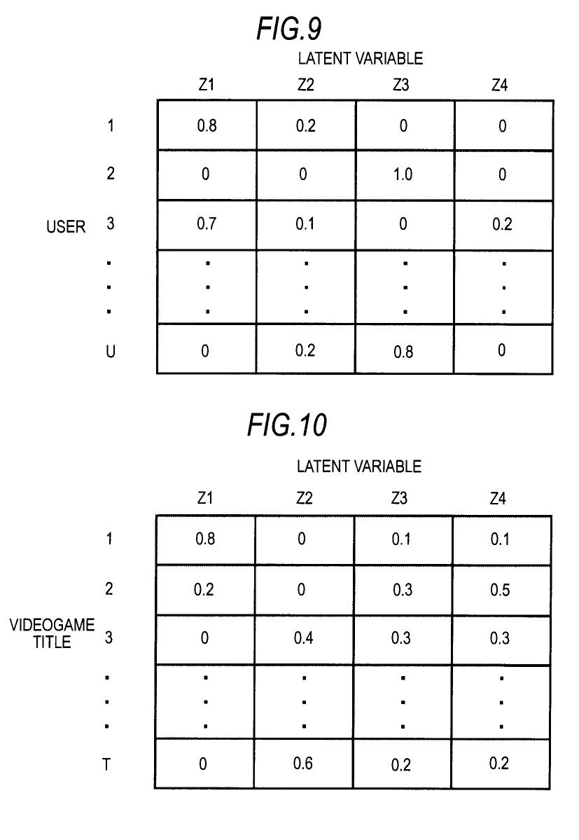

The clustering section 28 clusters the users by executing a dimensional reduction based on the PLSA with reference to the matrix corresponding to each use status. FIG. 9 illustrates an example of the short-period BF matrix of which the dimension is reduced, where the videogame titles 1 to T arranged along the horizontal axis of FIG. 8 are compressed into four latent dimensions. In each cell of FIG. 9, the probability of the user's latent dimension is set, and the clustering section 28 classifies each user as the cluster having the maximum probability of the latent dimension. The same applies to the case where the number of clusters is eight or sixteen.

The clustering process of the clustering section 28 will be specifically described. Here, a process for one type of matrix (for example, a short-period BF matrix) is shown. Furthermore, it is assumed that a plurality of users is denoted by uᵢ (i=1 . . . U) and a plurality of videogame titles is denoted by tⱼ (j=1 . . . T). Further, it is assumed that a latent variable (the number of clusters in the cluster set) is denoted by zₖ (k=1 . . . Z).

The clustering section 28 calculates p (uᵢ|zₖ) p (tⱼ|zₖ), p(zₖ) by applying the PLSA to the data of the matrix. The p(uᵢ|zₖ) indicates the conditional occurrence probability of each user with respect to each latent variable, p(tⱼ|zₖ) indicates the conditional occurrence probability of each videogame title with respect to each latent variable, and p(zₖ) indicates the occurrence probability of each latent variable.

In the cluster cᵢ where the user uᵢ belongs, since p(uᵢ) is constant with respect to the user uᵢ, cᵢ=argₖmax p(zₖ, uᵢ)=argₖmax p(zₖ|uᵢ)=argₖmax p(uᵢ|zₖ) p(zₖ) is established.

The clustering section 28 decides on zₖ which satisfies the above relationship as the cluster cᵢ to which the user uᵢ belongs. Furthermore, FIG. 9 shows p(zₖ|uᵢ).

The popular content deciding section 30 executes the popular content deciding process of FIG. 5. The popular content deciding section 30 acquires the short-period reproduced title with respect to the user belonging to each cluster of the first to third cluster sets from the use status storage section 20. Then, the popular content deciding section 30 decides the popularity degree of each content item on the basis of the counted value (for example, the total sum of the videogame titles reproduced once or more for the recent three months in the content reproduction device 14) of the short-period reproduced title of each user. Specifically, the popular content deciding section 30 applies the higher popularity rank to the content as the counted value of the short-period reproduced title becomes larger. Then, the popular content deciding section 30 applies points (for example, 100 points in the case of the first rank, 90 points in the case of the second rank, 80 points in the case of the third rank, and the like, which is hereinafter referred to as “title points”) set in advance in accordance with the popularity rank to each content item.

As a modified example, the popular content deciding section 30 may apply the counted value of the short-period reproduced title to the title point representing the popularity degree. Further, the popularity degree of each content item may be decided in accordance with the average of the counted value of the number of the short-period activation times and long-period activation times or the number of the long-period activation times instead of the number of the short-period activation times. Further, the popular content deciding section 30 may calculate the ratio (hereinafter, referred to as a “reproduction person ratio”) of the number of the users reproducing the content among the total users in the cluster. Then, the larger title points than those of the content in which the reproduction person ratio is relatively low may be applied to the content in which the reproduction person ratio is relatively high. Further, the larger title point may be applied to the content as the reproduction person ratio thereof becomes higher.

The effectiveness determining section 32 evaluates a correlation between the content and the cluster in each of the first to third cluster sets. Then, the effectiveness determining section 32 determines that the clustering is effective as the correlation becomes higher, and sets a weighting to each cluster set in accordance with the effectiveness of the clustering. In other words, it is determined that the clustering is effective as the relationship (for example, dependency or causality) that the cluster is decided when the content is decided becomes stronger. Further, the larger weight is set to the cluster set as the effectiveness of the clustering thereof becomes higher. This is based on the experience of the present inventor that the users having similar behavior and preferences may be easily classified as the same cluster (that is, the clustering precision is high) when the clustering having a high correlation between the content and the cluster is executed.

The effectiveness determining process in the effectiveness determining section 32 will be described in detail. The effectiveness determining section 32 of the first embodiment calculates a conditional entropy H(Z, T) or H (Z|T) of the cluster with respect to each title as an index representing the correlation between the cluster (Z) and the videogame title (T). Since the correlation becomes lower as the entropy becomes higher, the effectiveness determining section 32 determines that the clustering becomes more effective as the entropy H(Z, T) or H (Z|T) becomes lower, and applies the larger weighting to the cluster set. The weighting value of the cluster set may be decided in advance, or may be set in a descending order, for example, 50, 25, 10, 5, 2, and 1.

In the dimension reduction based on the PLSA for the clustering of the above-described user, a relationship between the user and the latent variable is calculated, and the relationship between the videogame title and the latent variable is calculated. FIG. 10 illustrates an example of the short-period BF matrix of which the dimension is reduced, where the videogame titles 1 to T are arranged along the vertical axis and the horizontal axis are compressed into four latent dimensions. In each cell of FIG. 10, the probability of the videogame title is set. That is, p (zₖ, tⱼ), p(zₖ|tⱼ), and p(tⱼ) are also calculated by applying the PLSA to the original matrix data. FIG. 10 shows p(zₖ|tⱼ).

As the occurrence probability of a specific videogame title becomes higher than the others as in Z1 and Z2 of FIG. 10, in other words, the bias of the occurrence probability of the videogame title becomes larger and the dispersion thereof becomes larger, the entropy becomes smaller. On the other hand, when the occurrence probability of the videogame title is comparatively constant as in Z3 and Z4 of FIG. 10, in other words, the bias of the occurrence probability of the videogame title becomes smaller and the dispersion thereof becomes smaller, the entropy becomes larger. Accordingly, the effectiveness determining section 32 calculates the entropy H(Z, T) or H (Z|T) to be low as the cluster set includes many clusters having a large bias in the occurrence probability of the videogame title as in Z1 or Z2.

Specifically, the entropy may be calculated as H(Z, T)=Σ_{k,j}(p(zₖ, tⱼ) logp(zₖ, tⱼ)).

Furthermore, the entropy may be calculated as H(Z|T)=Σⱼ(p(tⱼ) H(Z|tⱼ))=−Σⱼ(p(tⱼ)Σₖ(p(zₖ|tⱼ) logp(zₖ|tⱼ)).

When the maximum value of the entropy is denoted by Hmax, in order to normalize the entropy of each cluster set, it may be determined that the clustering becomes more effective as (Hmax−H(Z, T))/Hmax or (Hmax−H(Z|T))/Hmax becomes larger.

The recommended content deciding section 34 executes the recommended content deciding process of FIG. 5, and decides the recommendation rank of the content with respect to each of the plurality of users. Specifically, in the eighteen types of cluster sets shown in FIG. 6, a cluster (hereinafter, referred to as a “user cluster”) where a specific user belongs is identified. Then, the title points of each user cluster are counted by taking into account the weighting based on the effectiveness of the cluster set therein, and the higher recommendation rank is applied to the content of which the counted title point becomes higher. As described above, the title point is counted by applying the larger weight thereto as much as the title point in the cluster set having the high effectiveness. The recommended content deciding section 34 executes the recommended content deciding process for each user, and stores information (ID or the like) representing the content of the high recommendation rank in the recommended information storage section 22 by correlating the information with each user.

For example, the recommended content deciding section 34 may count the result obtained by multiplying the weighting of each cluster set decided by the effectiveness determining section 32 by the title points in each user cluster decided by the popular content deciding section 30 for every videogame title. Further, the count result of the title point may be of the content of the high recommendation rank, and the identification information may be stored in the recommended information storage section 22 relating to the number of the content items simultaneously suggested as recommended content items to the content reproduction device 14. In the first embodiment, the information of the content of which the recommendation rank is within the top 10 is stored in the recommended information storage section 22 together with its rank.

The request receiving section 36 receives data (hereinafter, referred to as a “recommended information request”) requesting the acquisition of the recommended information from the content reproduction device 14 via the communication section 630. In the recommended information request, the user ID of the content reproduction device 14 and the screen ID displayed in the content reproduction device 14 are designated. The screen ID includes ID of a menu screen or a content details screen to be described later in the on-line store.

The recommended information providing section 38 acquires the ID of the recommended content corresponding to the user ID designated at the recommended information request from the recommended information storage section 22. Then, the recommended information providing section 38 acquires information of the content necessary in the screen ID designated in the recommended information request from the content information storage section 24 by using the ID of the recommended content as a key. For example, when the menu screen is designated, data of a thumbnail image of the recommended content is acquired. When the content detail screen in the on-line store is designated, the title name or the provider name of the content is further acquired. The recommended information providing section 38 provides the information of the content acquired from the content information storage section 24 as the recommended information for the content reproduction device 14 via the communication section 630.

Furthermore, the recommended information providing section 38 may provide the recommended information including a predetermined number of recommended content items for the content reproduction device 14. Further, the recommended information providing section 38 may provide the recommended information including the recommended content provided relating to the number in accordance with the layout (the number of the displayable content) of the display screen of the content reproduction device 14 for the content reproduction device 14. In the first embodiment, the recommended information related to the content of the first to fifth recommendation ranks and the recommended information related to the content of the sixth to tenth recommendation ranks may be appropriately switched and provided for the content reproduction device 14. Accordingly, the changed recommended information may be easily provided for the content reproduction device 14.

The recommended information provided for the content reproduction device 14 by the recommended information providing section 38 is displayed on the television monitor 204 via the GPU 302 or the like of the content reproduction device 14. Hereinafter, the display example of the recommended information in the content reproduction device 14 will be described.

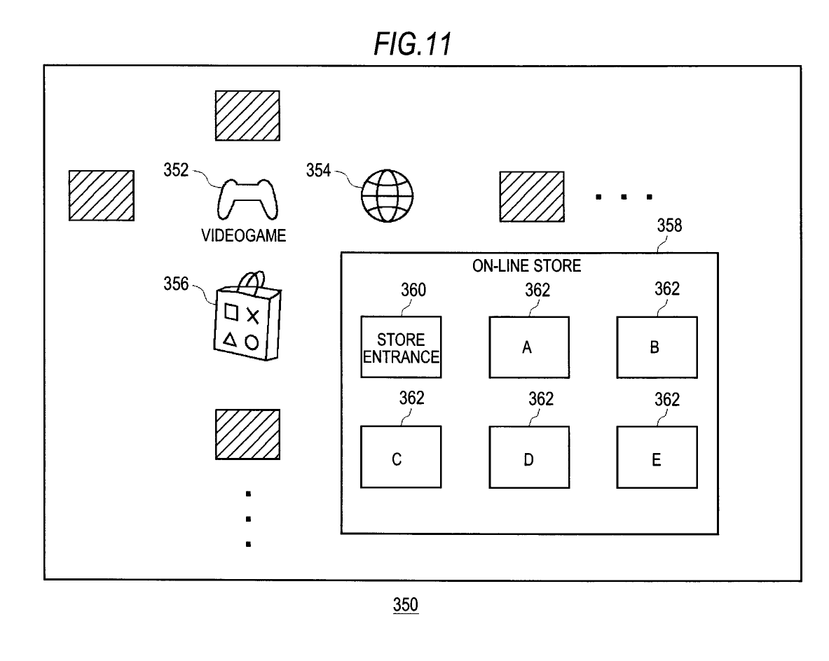

FIG. 11 illustrates a display example of the recommended information in the menu screen. A menu screen 350 is a basic screen of the content reproduction device 14, and is displayed when activating or finishing the content reproduction operation. In the menu screen 350, icons for selecting a large category are horizontally arranged. For example, the icons may include a videogame icon 352 for selecting a videogame, an Internet icon 354 for a connection to the internet, or the like. Further, icons for selecting a small category are vertically arranged. Here, the small category of the videogame icon 352 displays thereon an icon for selecting an installed videogame as well as a store icon 356 for accessing the on-line store. When the store icon 356 is selected, a recommended content display area 358 displays thereon a store entrance icon 360 displaying a top page of the on-line store as well as a thumbnail 362 of a recommended content provided for the content reproduction device 14 by the content recommendation device 12.

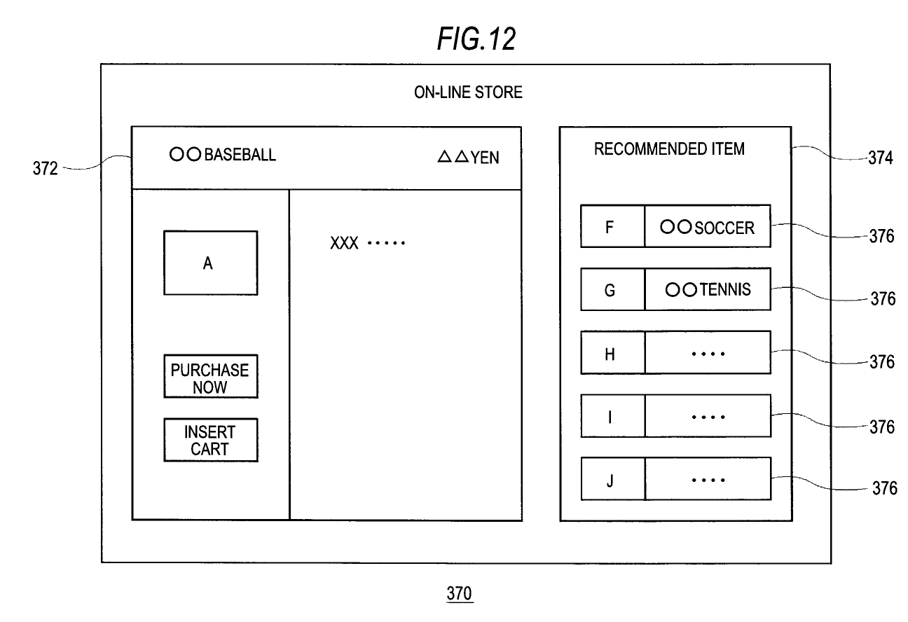

FIG. 12 illustrates a display example of the content detail screen in the on-line store. A content detail screen 370 is displayed when a detailed display of a specific content in the on-line store is requested or the specific thumbnail 362 in the recommended content display area 358 of FIG. 11 is selected. A selection content display area 372 is an area displaying thereon a title, detailed information, a price, a thumbnail image, and a buying button of content, and the display data is provided by the on-line store server 16. A recommended content display area 374 displays thereon the recommended information provided by the content recommendation device 12. In the same drawing, five individual content display areas 376 respectively display a thumbnail image, a title, a provider name, and the like of a recommended content.

The operation having the above-described configuration will be described below.

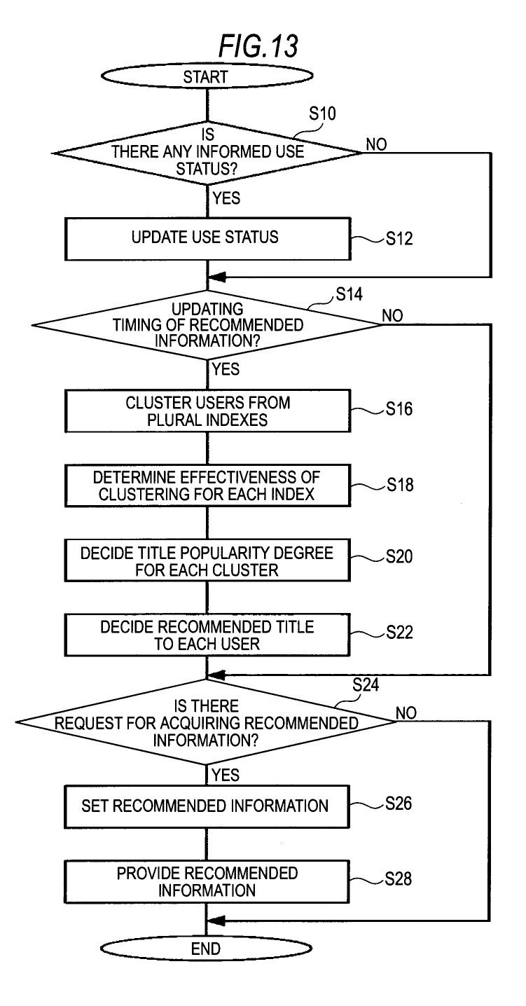

FIG. 13 is a flowchart illustrating an operation of the content recommendation device 12. In the flowchart of the specification, the process procedure of each section is denoted by the combination of S (initial of Step) meaning a step and a numeral. Further, when a certain process is executed in a determination process denoted by the combination of S and a numeral and the determination result is positive, Y (initial of Yes) is added thereto, for example, “Y of S10” is displayed. Conversely, when the determination result is negative, N (initial of No) is added thereto, and “N of S10” is displayed.

When the use status of the content is notified from the content reproduction device 14 (Y of S10), the use status acquiring section 26 sequentially updates the use status data stored in the use status storage section 20 (S12). When there is no notification (N of S10), S12 is skipped. When the update timing of the recommended information (Y of S14) is reached, the clustering section 28 executes the clustering of the users on the basis of the six types of use status data, and creates the first to third cluster sets corresponding to the use status data (S16). The update timing may be set to a predetermined time or a time elapsed from a previous updating time by a predetermined period.

The effectiveness determining section 32 determines the effectiveness of the clustering for each cluster set, and applies a weighting to each cluster set (S18). The popular content deciding section 30 decides the popularity rank of the content in each cluster of each cluster set (S20). The recommended content deciding section 34 specifies the user cluster to which the user who becomes the recommendation partner belongs as each cluster set, and counts the popularity rank of the content in each user cluster by taking account of a weighting of each cluster set therein. Then, the recommended content deciding section 34 decides the recommendation rank of the content to each user and stores it in the recommended information storage section 22 (S22). When it is not the updating timing of the recommended information (N of S14), S16 to S22 are skipped.

When the request receiving section 36 receives the recommended information request from the content reproduction device 14 (Y of S24), the recommended information providing section 38 sets the recommended information representing the recommended content with respect to the user of the content reproduction device 14 by referring to the recommended information storage section 22 and the content information storage section 24 (S26). The recommended information providing section 38 displays the recommended content to the user in the content reproduction device 14 by transmitting the data of the recommended information to the content reproduction device 14 (S28). When the recommended information request is not received (N of S24), S26 and S28 are skipped.

According to the content recommendation device 12 of the first embodiment, the final recommended content is decided by taking into account and estimating the effectiveness of the clustering to the popularity degree of each content item in the user cluster to which the user who becomes the recommendation partner belongs. Accordingly, the content of the recommended content or the suggestion thereof may be adjusted in accordance with whether the clustering is effective, and the precision of the recommended content may be improved. Furthermore, in the first embodiment, a plurality of types of cluster sets is set, but even when only one cluster set is selected, the effectiveness of the clustering may be usefully evaluated. For example, when the effectiveness of the clustering is high, the recommended content is decided on the basis of the popularity degree of the user cluster. When the effectiveness of the clustering is low, the recommended content may be decided by other methods (a method of statically setting a videogame title of a sales promotion object).

Further, according to the content recommendation device 12, the clustering is executed by a plurality of types of input datas realted to the use of the content, and a plurality of types of cluster sets is created in accordance with the input data. Then, the popularity degree of the content in the user cluster is counted by dynamically adding the weighting in accordance with the effectiveness of each cluster set thereto, and the recommended content is decided. Accordingly, as the effectiveness of the clustering result of the user cluster becomes higher, the popularity degree of the user cluster gets reflected in the final recommended content. In this manner, when a plurality of types of clusterings is executed and the effective clustering is reflected in the recommended content by adding a weighting thereto, the precision of the recommended content may be improved even when it is difficult to decide the type of the effective clustering at one time in advance.

Further, according to the content recommendation device 12, the popularity degree (that is, the title points) of the content in each cluster is decided on the basis of the reproduced content (that is, the reproduced title) in the content reproduction device 14. Since the number of activation times or the reproduction period of the content is different in accordance with the content or the genre thereof, it may be difficult to equally evaluate a plurality of types of content items. On the contrary, when the content items are evaluated on the basis of the reproduced title, it is easy to decide the popularity degree by equally evaluating the plurality of types of content items.

Furthermore, the input data of the clustering, the counting period thereof, or the number of clusters included in the cluster set may be appropriately examined again, and a new type of input data, a counting period thereof, and a cluster set may be appropriately added. In this manner, the recommended information providing system 100 capable of flexibly changing the structure deciding the recommended content in accordance with the effectiveness evaluation conducted by a manager may be realized. For example, as the input data of the clustering, an evaluation degree of a user with respect to content or a progress status of content (for example, an achievement rate or the like in a videogame) may be added.

As described above, the first embodiment of the present disclosure has been described. The embodiment is merely an example, and it should be understood by persons skilled in the art that the combination of the respective constituents or the respective processes may be modified in various forms and the modification examples thereof are also include in the scope of the present disclosure. Hereinafter, the modified examples will be described.

A first modified example will be described. In the first embodiment, the effectiveness determining section 32 dynamically decides the weighting of the cluster set by determining the effectiveness of the clustering. In the modified example, the weighting of the cluster set may be statically decided in advance by a manager of the recommended information providing system 100. For example, the weighting may be decided in advance in consideration of the feature of the cluster set.

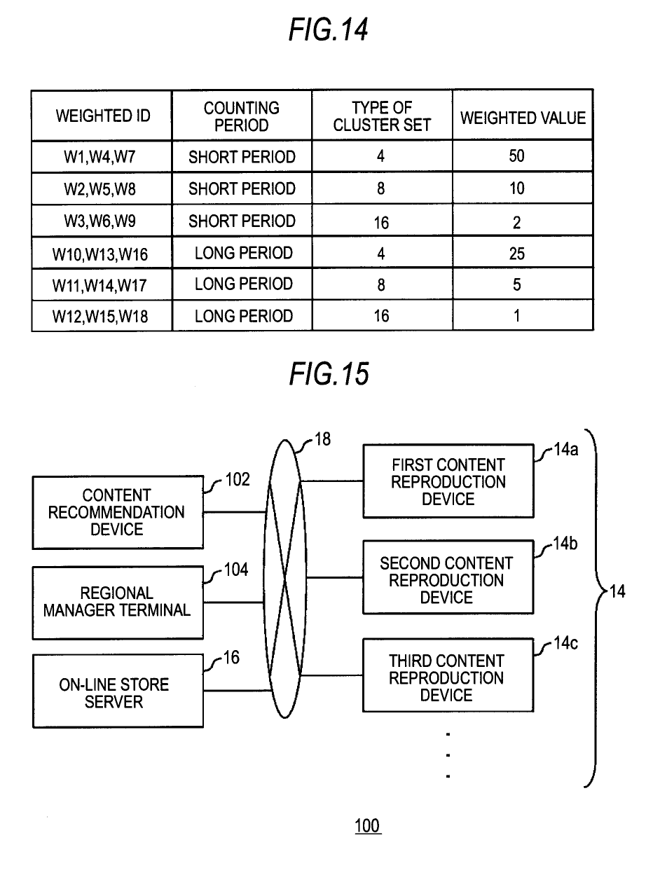

FIG. 14 illustrates a setting example of the weighting of the cluster set. The weighting IDs of the same drawing respectively correspond to W1 to W18 of FIG. 6. In the example of FIG. 14, when the counting period is the same, the larger weighted value is applied to the cluster set as the number of the clusters included in the cluster set becomes smaller. Accordingly, the popularity degree of the content in the detailed user classification may be added while focusing on the popularity degree of the content in the rough user classification. In the rough user classification, the popular content is the content that is supported by a large number of users having roughly similar preferences. On the other hand, in the detailed user classification, the popular content is the content which is supported by a comparatively small number of users having subdivided preferences. For this reason, in the experience of the present inventor the precision of the recommended content improves when the popular content in the rough user classification is weighted.

Further, in the example of FIG. 14, when the number of the clusters is the same, the larger weight is applied to the short-period cluster set rather than the long-period cluster set. This is because in the experience of the present inventor the closest popular content more stimulates the user buying intension and the content items of the recommended content comparatively easily change. Furthermore, the weighting of the cluster set may be appropriately examined again by the manager determining the effect of providing the recommended information through the content recommendation device 12.

A second modified example will be described. In the first embodiment, the effectiveness determining section 32 determines the correlation degree between the cluster Z and the title T by using the entropy H (Z, T) or H (Z|T) of the cluster with respect to each title. In the modified example, the correlation degree between the cluster Z and the title T may be determined by using the mutual information amount I(Z;T) instead of the entropy. Specifically, the effectiveness determining section 32 may obtain the mutual information amount I(Z;T) as shown in the following expression 1. Further, since the mutual dependency between Z and T becomes stronger as the mutual information amount thereof becomes larger, it may be determined that the clustering becomes more effective as the mutual information amount becomes larger.

$$I ( Z ; T ) = {\sum }_{k} {\sum }_{j} p ( {z}_{k} , {t}_{j} ) log \frac{p ( {z}_{k} , {t}_{j} )}{p ( {z}_{k} ) p ( {t}_{j} )}$$

Furthermore, in order to normalize the mutual information amount, the effectiveness determining section 32 calculates a value by dividing the mutual information amount I(Z;T) by the entropy H(Z), and may determine that the clustering becomes more effective as the value becomes larger.

A third modified example will be described. The effectiveness determining section 32 may determine the correlation degree between the cluster Z and the title T by using the correlation degree I (Z;T)/H (Z, T), that is, the ratio of the mutual information amount with respect to the entropy. Further, the effectiveness determining section 32 may determine that the clustering becomes more effective as the correlation degree becomes larger.

A fourth modified example will be described. In the first embodiment, the popular content deciding section 30 counts the number of the reproduced titles in the content reproduction device 14 in every cluster, and decides the popularity rank of each content item in each cluster. Then, the title points in accordance with the popularity rank are applied to each content item. As a modified example of deciding the popularity rank, the popularity rank of each title may be decided in accordance with the correlation degree of each title in each cluster, for example, the occurrence probability p(tᵢ|zₖ). Specifically, as the correlation of the title with a certain cluster becomes higher, for example, the occurrence probability of the title in a certain cluster becomes higher, the higher popularity rank may be applied to the cluster.

Further, in order to bring up the popularity rank of the title concentrating on the specific cluster, the occurrence probability p(tᵢ|zₖ) of each title in each cluster may be weighted by the entropy H(Z|tⱼ) in the cluster set with respect to the specific title. For example, as p (tⱼ|zₖ)×(Hmax−H (Z|tⱼ)) of the title in a certain cluster becomes larger, the occurrence probability in the cluster becomes higher and the entropy in the cluster set becomes lower. For this reason, the higher popularity rank may be applied to the cluster.

Further, as a modified example of applying the title points, the occurrence probability or the value obtained by weighting the occurrence probability using the entropy in the cluster set may be applied to each content item as the title points.

A fifth modified example will be described. Although there is no special remark in the first embodiment, the recommended content deciding section 34 may first decide the recommended content to the user by counting the title points of each cluster, and further adjust the content of the recommended content in accordance with the feature information related to the user, the use status of the content by the user, the business rule, or the like. For example, the content reproduced in the content reproduction device 14 of the user of the recommendation object may be excluded from the recommended content to the user by referring to the use status storage section 20. Further, the content undesirable to be recommended to the user in accordance with the user's age may be excluded from the recommended content to the user by referring to the age limit set for the content. Further, the sales promotion object content may be included in the recommended content regardless of the title points.

A sixth modified example will be described. Although there is no special remark in the first embodiment, the clustering process using the clustering section 28 may be executed at a different timing from the updating timing of the recommended information (at the lower frequency). For example, even when the recommended information is updated every day, the clustering process may be executed at an interval of several days or one week. Accordingly, the process burden of the content recommendation device 12 may be reduced. Further, the comparatively stable recommended content may be obtained by continuously using the cluster set decided once for a certain period. Further, when the clustering process is not executed, the clustering process (for example, S16 and S18 of FIG. 13) may be skipped. In this case, the popularity rank of each content item of each cluster may be updated by using the cluster set decided in the preceding clustering process and the recent use status, and the recommended content to the user may be updated. Accordingly, the recommended information to the user may be updated while reducing the process burden of the content recommendation device 12.

A seventh modified example will be described. Although there is no special remark in the first embodiment, the clustering section 28 of the content recommendation device 12 may cluster the user on the basis of information (hereinafter, referred to as a “UAV (User Activity Vector)”) representing the content usage habits of each user. The UAV of the modified example is the same data equal to the number of activation times, the reproduction period, and the reproduced title of the first embodiment, and shows the usage frequency of the content during a predetermined period (for example, a predetermined time band or a day of the week) repeated in a predetermined cycle.

For example, as the UAV counted every day of the week, the total number of times of reproducing several content items in the content reproduction device 14 every day or the total time thereof may be counted and stored in the use status storage section 20. The clustering section 28 may cluster the user in accordance with the existing algorithm such as a k-means method on the basis of the usage frequency (for example, a seven-dimensional vector value) for every day of the user represented by the UAV. In the modified example, a new index clustering the user is suggested, and the process after the clustering (for example, after S18 of FIG. 13) is the same as that of the first embodiment.

Furthermore, as the UAV counted for each time band, the total number of times reproducing the content in the content reproduction device 14 or the counting period thereof may be counted every three hours obtained by dividing 24 hours by 8, and the result may be stored in the use status storage section 20. The clustering section 28 may cluster the user on the basis of the usage frequency (for example, an eight-dimensional vector value) for each time band of each user represented by the UAV.

Further, as the UAV counted for each day of the week and each time band, the total number of times reproducing the content in the content reproduction device 14 or the counting period thereof may be counted every fifty six types of periods obtained by the combination of the days (seven types) and the time bands (here, eight types), and may be stored in the use status storage section 20. The clustering section 28 may cluster the user on the basis of the fifty six-dimensional vector represented by the UAV. Furthermore, since the present inventor considers that the fifty six-dimensional vector has a rough value in general, it is desirable to execute the dimension reduction using the PLSA before the clustering using the K-means method or the like.

According to the modified example, the recommended information may be decided by taking into account the content usage habit of the user therein. For example, as the recommended information to the user of the recommendation object, the popular content between other users having similar habits may be suggested. Furthermore, the UAV may be recorded as the behavior using a certain content item throughout various genres by excluding the content items of the content or recorded for each genre (a sport, an RPG, or the like) of the content.

An eighth modified example will be described. The content recommendation device 12 may further include an adjustment information receiving section which receives adjustment data for executing the adjustment with respect to the decision of the recommended content from the terminal of the manager to be managed the recommended information using the content recommendation device 12. The recommended content deciding section 34 of the first embodiment updates the weighting decided to be applied in accordance with the effectiveness of the cluster set on the basis of the adjustment data received from the manager. For example, the adjustment data may increase or decrease the dispersion of the weighting to be applied to each cluster set, and is set by the determination of the manager.

Further, the recommended content deciding section 34 of the first modified example updates the weighting based on the number of the clusters included in the cluster set and the weight based on the counting period of the use status in accordance with the adjustment data received from the manager. For example, the adjustment data may increase or decrease the dispersion of the weighting to be applied to each cluster set. Further, the weighting application reference may be reversed. For example, a larger weighting may be applied as the number of the clusters included in the cluster set becomes larger, or a larger weighting may be applied as the counting period becomes longer. Further, the recommended content deciding section 34 of the first embodiment and the first modified example may first use the weighting represented by the adjustment data instead of the predetermined weighting when the adjustment data designates the weighting.

According to the modified example, the weighting decided in advance to be applied to each user cluster or the weighting automatically decided by the calculation based on the effectiveness of the clustering may be appropriately corrected by the manager. Accordingly, the content may be recommended by reflecting the manager's plan with respect to the sales of the content.

### Second Embodiment

FIG. 15 illustrates a configuration of a recommended information providing system of a second embodiment. The recommended information providing system 100 of the second embodiment has a configuration corresponding to that of the recommended information providing system 10 of the first embodiment, and further includes a regional manager terminal 104. Hereinafter, the content described in the first embodiment will be appropriately omitted.

A content recommendation device 102 corresponds to the content recommendation device 12 of the first embodiment, and provides display data (hereinafter, simply referred to as a “recommendation display screen”) of the recommended information of the content to the content reproduction device 14. The hardware configuration is the same as that of FIG. 4.

The regional manager terminal 104 is a PC terminal which is operated by each of the regional managers who are in charge of the sales of the content in Japan, North America, Europe, and the like, and the hardware configuration is also the same as that of FIG. 4. The regional manager terminal 104 transmits information (hereinafter, referred to as “regional setting information”) decided by the regional manager and sends a method of recommending the content in each region to the content recommendation device 102. The regional setting information includes the three types of information below.

### (1) Regional Sales Promotion Information:

The regional sales promotion information indicates information representing the content (hereinafter, referred to as a “sales target title”) of the sales promotion object in a specific region. Furthermore, the sales target title includes a “normal recommended title” representing the content (to be included on the recommendation screen) to be recommended to the user at all times regardless of the type selected to be suggested to the user among a plurality of types of recommended content.

### (2) Regional Layout Information:

The regional layout information indicates information representing the layout of the recommendation display screen in a specific region. Specifically, the regional layout information is used to decide the arrangement method of the recommended content in the recommendation display screen.

### (3) Regional Switching Rule:

The regional switching rule indicates information deciding the type of the recommended information provided for the user in a specific region and a switching interval as a condition switching the type thereof, in other words, a period of providing a specific type of recommended information.

Furthermore, one regional manager terminal 104 is shown in FIG. 15, but the recommended information providing system 100 may, of course, include a plurality of regional manager terminals 104 corresponding to a plurality of regional managers.

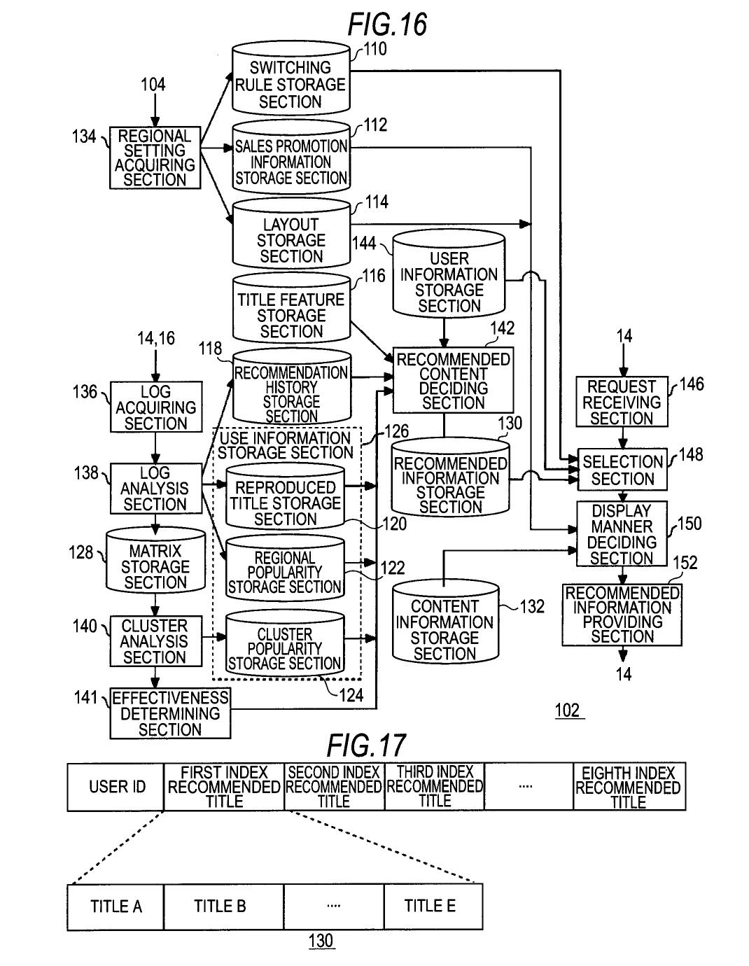

FIG. 16 is a block diagram illustrating a functional configuration of the content recommendation device 102 of FIG. 15. The content recommendation device 102 includes a switching rule storage section 110, a sales promotion information storage section 112, a layout storage section 114, a title feature storage section 116, a recommendation history storage section 118, a reproduced title storage section 120, a regional popularity storage section 122, a cluster popularity storage section 124, a use information storage section 126, a matrix storage section 128, a recommended information storage section 130, a content information storage section 132, and a user information storage section 144 which are storage areas for storing various data therein. Furthermore, the content recommendation device 102 includes a region setting acquiring section 134, a log acquiring section 136, a log analysis section 138, a cluster analysis section 140, a effectiveness determining section 141, a recommended content deciding section 142, a request receiving section 146, a selection section 148, a display manner deciding section 150, and a recommended information providing section 152 which are functional blocks for executing various data processes.

A program module of each functional block of FIG. 16 may be stored in the removable recording medium 626 of FIG. 4 and be installed in the storage section 634. Further, each functional block for the data process of FIG. 16 may be executed by the main CPU 600 or the GPU 602 while being appropriately loaded on the main memory 608.

The user information storage section 144 stores feature information related to each of a plurality of users. In the second embodiment, at least a correlation between each user ID and a regional area ID of each user is stored.

The recommended information storage section 130 stores information which is related to the content to be recommended to the user and is decided by the recommended content deciding section 142. FIG. 17 illustrates a configuration example of data stored in the recommended information storage section 130. The recommended information storage section 130 stores a plurality of types of recommended titles decided on the basis of a plurality of types of indexes correlated to each user ID. In the second embodiment, eight types of recommended titles are stored. Each recommended title stores the IDs of a plurality of content items (a videogame title and a videogame application) decided as the recommended content on the basis of the specific index while the IDs are sorted in an order of the recommendation rank.

Returning to FIG. 16, the switching rule storage section 110 stores the regional switching rule. For example, in the regional switching rule of Japan, the first to eighth index recommended titles may be set to be sequentially switched for one day. On the other hand, in the regional switching rule of North America, the first to fifth index recommended titles may be set to be sequentially switched for two days. Further, the recommended title switching sequence may be further set in an order of the second index recommended title, the eighth index recommended title, the fifth index recommended title, and the like. The sales promotion information storage section 112 stores the regional sales promotion information. For example, the sales promotion information storage section 112 may store the IDs of one or more sales target titles.

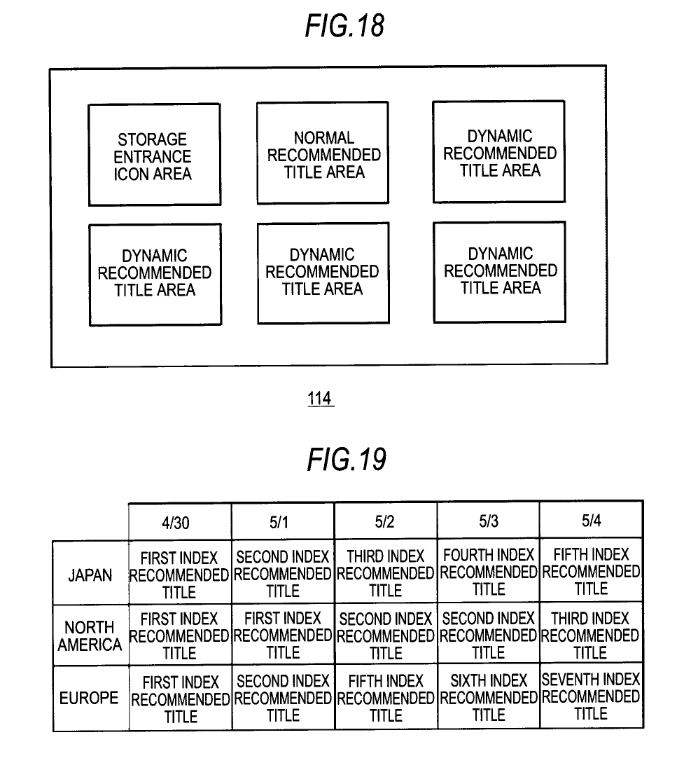

The layout storage section 114 stores the regional layout information. For example, the layout storage section 14 stores the arrangement manner of the thumbnail 362 in the recommended content display area 358 of FIG. 11 or the arrangement manner of the individual content display area 376 in the recommended content display area 374 of FIG. 12. FIG. 18 schematically illustrates the regional layout information. In the same drawing, as the display manner of the recommended content display area 358, one of five thumbnail image setting areas excluding the store entrance icon 360 is normally set as the recommended title setting area, and the other four areas are set as the recommended title setting areas which are actively switched in accordance with the regional switching rule.

Returning to FIG. 16, the title feature storage section 116 stores feature information related to each of the plurality of content items. Specifically, as for each videogame title, information representing a genre, other related titles (referred to as a “related series”), or related items (referred to as a “related item”) is stored. For example, as the related series of the game title “00 baseball 8”, the ID of “00 baseball 7” or “00 golf” of the same series may be stored. Further, as the related item, the ID of the character commodity or the CD storing the BGM of “00 baseball 8” may be stored.

The recommendation history storage section 118 stores information representing the content having been recommended to each content reproduction device 14 (that is, each user). The reproduced title storage section 120 stores information (the reproduced title in the first embodiment) representing the content having been reproduced, in other words, having been used in the content reproduction device 14.

The regional popularity storage section 122 stores information (hereinafter, referred to as a “regional popular title”) representing the popularity status of each content item in each of the regions such as Japan, North America, and Europe. In the second embodiment, the following three types of information are stored as the regional popular title.

(1) Regional Popular Title based on Number of Reproduction Users:

The regional popular title indicates information representing the popularity rank of each videogame title by applying the higher popularity rank as the number of the users of the content becomes larger after the number of the users who reproduced each videogame title is counted for each region.

(2) Regional Popular Title based on Progress Degree:

The regional popular title indicates information representing the popularity rank of each game title by applying the higher popularity rank as the progress degree of the videogame title becomes higher (for example, the number of times of clearing the videogame becomes larger) after the videogame progress degree of the videogame by each user is counted for each region.

### (3) Regional Popular Title Based on Evalulation Degree:

The regional popular title indicates information representing the popularity rank of each videogame title by applying the higher popularity rank as the evaluation of the videogame title becomes higher after the evaluation of each videogame title by each user is counted for each area.

The cluster popularity storage section 124 stores information (hereinafter, referred to as a “cluster popular title”) representing the popularity degree of each content item in each cluster with respect to the cluster as the group of the users having similar activities and preferences. Specifically, the process result of the popular content deciding section 30 of the first embodiment, in other words, the popularity rank within the cluster of FIG. 6 is stored.

Furthermore, the reproduced title storage section 120, the regional popularity storage section 122, and the cluster popularity storage section 124 serve as functional blocks storing information related to the use of the content by the user, and are comprehensively positioned in the use information storage section 126.

The matrix storage section 128 stores various matrix data as original data of the clustering. Specifically, the short-period BF matrix, the long-period BF matrix, the short-period PT matrix, the long-period PT matrix, the short-period UT matrix, and the long-period UT matrix of the first embodiment are stored. The content information storage section 132 corresponds to the content information storage section 24 of the first embodiment, and stores a variety of information related to the plurality of content items.

The region setting acquiring section 134 acquires the regional setting information set by the regional manager of each region from the regional manager terminal 104. Then, the regional switching rule among the regional setting information is stored in the switching rule storage section 110, the regional sales promotion information is stored in the sales promotion information storage section 112, and the regional layout information is stored in the layout storage section 114.

The log acquiring section 136 acquires the videogame status log, the progress status log, and the evaluation status log from the content reproduction device 14 of the user residing at each region. Further, the buying history log is acquired from the content reproduction device 14 or the on-line store server 16, and the recommendation history log are acquired from a predetermined storage area of the content recommendation device 102. In the videogame status log, the number of times of reproducing the videogame title by the user and the reproduction period thereof are recorded. In the progress status log, the videogame progress degree by each user (for example, a ratio of a cleared stage among a plurality of stages to be cleared, and the like) is recorded. In the evaluation status log, the evaluation degree of each videogame title by each user is recorded. In the buying history log, the videogame title bought by the user, in other words, installed in the content reproduction device 14 is recorded. In the recommendation history log, the videogame title recommended to each user is recorded.

The log analysis section 138 analyzes various log information and updates various databases on the basis of the analysis result. Specifically, the reproduced title of each user is stored in the reproduced title storage section 120, and the various matrix data is set and stored in the matrix storage section 128 with reference to the videogame status log and the buying history log. Further, the recommendation history of the recommendation history storage section 118 is updated by storing the videogame title recommended to each user in the recommendation history storage section 118 with reference to the recommendation history log.

Further, the log analysis section 138 sets the regional popular titles (based on the number of times of reproducing the content) by counting the number of times of reproducing each videogame title in each region with reference to the videogame status log, and stores the result in the regional popularity storage section 122. The log analysis section 138 sets the regional popular titles (based on the progress degree) by counting the progress status of each videogame title in each region with reference to the progress status log, and stores the result in the regional popularity storage section 122. For example, the popularity rank may become higher as the average progress degree of the videogame title becomes larger. Further, the log analysis section 138 sets the regional popular title (based on the evaluation degree) by counting the evaluation status of each videogame title in each region with reference to the evaluation status log, and stores the result in the regional popularity storage section 122.

The cluster analysis section 140 corresponds to the clustering section 28 and the popular content deciding section 30 of the first embodiment, and creates a plurality of types of clustering sets on the basis of the matrix data stored in the matrix storage section 128. Then, the cluster analysis section 140 sets the title points in each cluster of each cluster set, and stores information (the popularity rank within the cluster of the first embodiment) representing the popularity degree of each content item in each cluster as the cluster popular title in the cluster popularity storage section 124.

The effectiveness determining section 141 corresponds to the effectiveness determining section 32 of the first embodiment, determines the effectiveness of the clustering using the cluster analysis section 140, and applies the weighted value in accordance with the effectiveness degree to each cluster set.

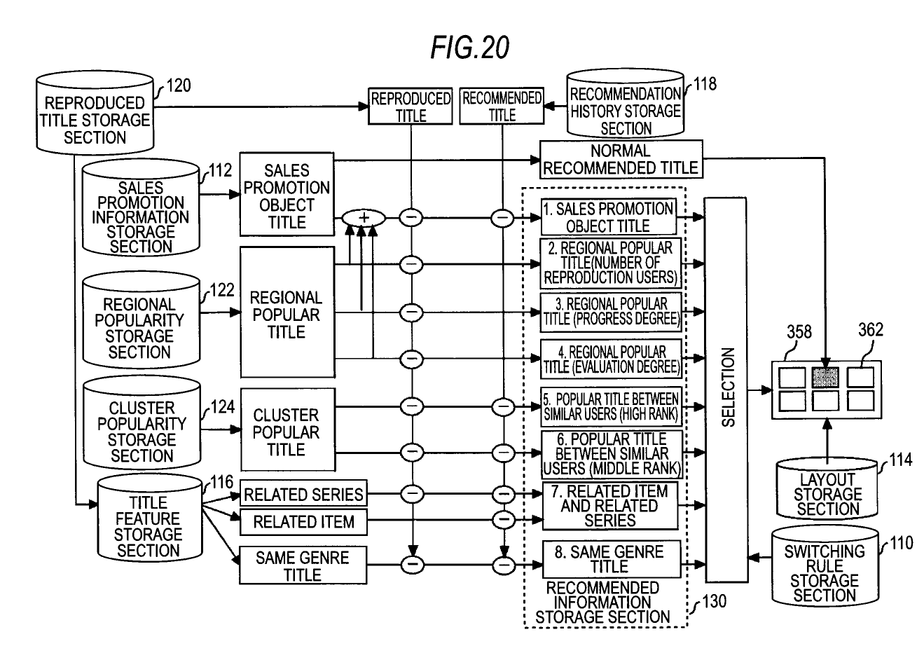

The recommended content deciding section 142 sets eight types of recommended titles (the first to eighth index recommended titles) by referring to the stored data of each of the user information storage section 144, the sales promotion information storage section 112, the title feature storage section 116, the recommendation history storage section 118, the reproduced title storage section 120, the regional popularity storage section 122, and the cluster popularity storage section 124, and stores the result in the recommended information storage section 130. The method of setting the recommended title will be described later by referring to FIG. 20.

When the regional switching rule of the recommendation history storage section 118 is updated, the selection section 148 sets and stores the selection convention of the recommended title by referring to the regional switching rule. FIG. 19 illustrates an example of the selection convention of the recommended title. In the same drawing, the selection convention is shown in which the regional switching rule of Japan sets the first to eighth index recommended titles to be switched every day. Further, the selection conventions are shown in which the regional switching rule of North America sets the first to eighth index recommended titles to be switched every two day and the regional switching rule of Europe sets the first to third index recommended titles and the fifth to eighth index recommended titles to be switched every day.

Returning to FIG. 16, the request receiving section 146 receives the recommended information request from the content reproduction device 14 via the communication section 630 as in the request receiving section 36 of the first embodiment. The recommended information request of the second embodiment also includes the user ID and the screen ID.

The selection section 148 specifies the regional ID of the user in accordance with the user ID of the recommended information request by referring to the user information storage section 144, and specifies the type of the recommended title to be provided for the user by referring to the record corresponding to the regional ID in the selection convention. In other words, any one of the first to eighth index recommended titles is selected with respect to the recommended information request from the content reproduction device 14. Then, a specific type of recommended title corresponding to the user ID of the recommended information request is acquired from the recommended information storage section 130, and is notified to the display manner deciding section 150.

The display manner deciding section 150 specifies the regional sales promotion information and the regional layout information corresponding to the regional ID (that is, the region where the user resides) specified by the user ID by referring to the sales promotion information storage section 112 and the layout storage section 114. Then, the display manner of the recommended information suggested to the user is decided in accordance with the regional sales promotion information and the regional layout information. Specifically, in the normal recommended title area of the recommendation screen, the normal recommended title designated in the regional sales promotion information of the sales promotion information storage section 112 is set. On the other hand, in the dynamic recommended title area, the recommended title received from the selection section 148 is set. Then, the related data (the thumbnail image and the like) of each title to be set in the recommendation screen is acquired from the content information storage section 132 and is set as the data of the recommendation screen.

The recommended information providing section 152 provides the data of the recommendation screen set by the display manner deciding section 150 for the content reproduction device 14 as the recommended information request source. The data of the recommendation screen is, for example, the display data of the recommended content display area 358 of FIG. 11 or the display data of the recommended content display area 374 of FIG. 12. The recommended information providing section 152 sequentially stores information representing the recommended content items suggested to the user as the recommendation history log in a predetermined storage area.

FIG. 20 is a schematic diagram illustrating a procedure of setting the recommended information in the content recommendation device 102. Here, a procedure of setting the recommended information with respect to one user (hereinafter, referred to as a “recommendation object user”) will be described.

The recommended content deciding section 142 specifies the sales target title of the region where the recommendation object user resides by referring to the sales promotion information storage section 112. Then, the reproduced title of the user stored in the reproduced title storage section 120 is excluded from the sales target title. Furthermore, the recommended title having been recommended to the user stored in the recommendation history storage section 118 is also excluded. The recommended information providing section 152 decides the remaining videogame title as the first index recommended title. Furthermore, when the sales target title is not designated by the regional manager or the designated number is a predetermined number or less, the recommended content deciding section 142 uses the result obtained by appropriately combining the regional popular titles (based on the number of reproduction users, the progress degree, and the evaluation degree) as the sales target title.

Further, the recommended content deciding section 142 specifies the regional popular titles of the region where the recommendation object user resides by referring to the regional popularity storage section 122. Then, the result obtained by excluding the reproduced title of the user from the regional popular titles (the number of reproduction users) is decided as the second index recommended title. In the same manner, the results obtained by excluding the reproduced title of the user from the regional popular titles (the progress degree) and the regional popular title (the evaluation degree) are respectively decided as the third index recommended title and the fourth index recommended title.

Furthermore, the recommended content deciding section 142 decides the recommended title from the cluster popular titles stored in the cluster popularity storage section 124 in the same manner as the recommended content deciding section of the first embodiment. Specifically, the popular videogame titles between the users having similar behavior or preferences is specified by counting the title points of the plurality of user clusters while the effectiveness of each cluster set decided by the effectiveness determining section 141 is added thereto. The recommended content deciding section 142 excludes the recommended titles and the reproduced titles of the user from the popular videogame titles between the similar users. Then, the videogame titles located at the high rank (for example, the counted value of the title points is first to fifth) among the remaining videogame titles is decided as a fifth index recommended title, and the videogame titles located at the middle rank (for example, the counted value of the title point is sixth to tenth) are decided as a sixth index recommended titles.

Moreover, the recommended content deciding section 142 specifies the related series and the related item of the reproduced title of the user by referring to the title feature storage section 116. Then, the result obtained by excluding the reproduced titles and the recommended titles of the user from the related series and the result obtained by excluding the recommended titles of the user from the related items are decided as seventh index recommended titles.

Further, the recommended content deciding section 142 retrieves the title of the same genre as that of the reproduced title of the user from the title feature storage section 116, and decides the result obtained by excluding the reproduced titles and the recommended titles of the user from the title of the same genre as eighth index recommended titles. At this time, the recommended content may be selected from each genre in accordance with the ratio of the genre in the reproduced content of the user. In other words, as the ratio of the genre in the reproduced content of the user becomes higher, many recommended content items may be selected from the genre.

The selection section 148 selects any one of the first to eighth index recommended titles by referring to the selection convention set by the regional switching rule of the region where the user resides. The display manner deciding section 150 sets the display screen data of the recommended information in which the normal recommended titles and the recommended titles selected by the selection section 148 are appropriately disposed in accordance with the regional layout information of the region where the user resides. For example, when the normal recommended title is designated, the thumbnail image and the like thereof are set in the area of the recommendation screen set by the regional manager in advance.

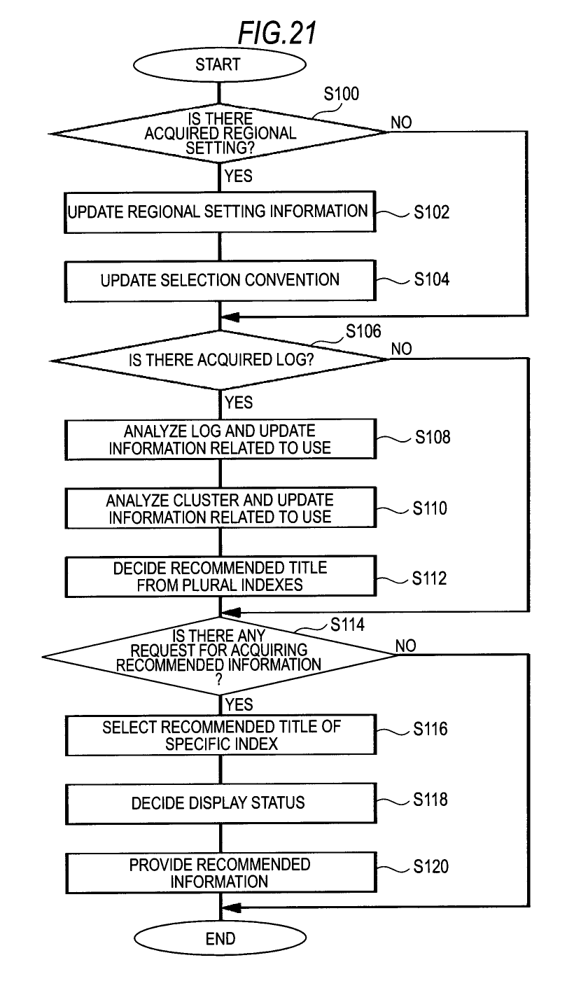

The operation using the above-described configuration will be described below. FIG. 21 is a flowchart illustrating an operation of the content recommendation device 102. When the regional setting information is received from the regional manager terminal 104 (Y of S100), the region setting acquiring section 134 updates the regional switching rule stored in the switching rule storage section 110, the regional sales promotion information stored in the sales promotion information storage section 112, and the regional layout information stored in the layout storage section 114 (S102). The selection section 148 updates the selection convention of the recommended title in accordance with the updating content of the regional switching rule (S104). When the regional setting information is not received (N of S100), S102 and S104 are skipped.

The log acquiring section 136 periodically acquires various logs from the external devices such as the content reproduction device 14 and the on-line store server 16. When various logs are acquired (Y of S106), the log analysis section 138 updates the stored data of the recommendation history storage section 118, the use information storage section 126, and the matrix storage section 128 by analyzing the data of various logs (S108). The cluster analysis section 140 clusters the user on the basis of the matrix stored in the matrix storage section 128, decides the popularity degree of the videogame title in each cluster, and stores the process result in the use information storage section 126 (S110). The recommended content deciding section 142 decides a plurality of types of recommended titles corresponding to a plurality of indexes by referring to the plurality of indexes stored in a plurality of databases, and stores the result in the recommended information storage section 130 (S122). When the log is not acquired (N of S106), S108 to 5112 are skipped.

When the request receiving section 146 receives the recommended information request from the content reproduction device 14 (Y of S114), the selection section 148 selects the type of the recommended titles in accordance with the region where the user resides on the basis of the selection convention (S116). The display manner deciding section 150 sets the data of the recommendation screen in which the recommended titles (including the normal recommended title) are disposed on the basis of the regional layout information in accordance with the user stay region (S118). The recommended information providing section 152 provides the data of the recommendation screen for the content reproduction device 14 to be displayed thereon (S120). When the recommended information request is not received (N of S114), S116 to S120 are skipped.

Furthermore, the processes of 5100 to 5112 of FIG. 21 may be executed by a batch process at a predetermined frequency of three days or the like or a predetermined time band such as night. On the other hand, the processes of 5114 to 5120 are executed on demand when the recommended information request is received from the content reproduction device 14.

According to the content recommendation device 102 of the second embodiment, the plurality of types of recommended titles based on the plurality of types of indexes is switched, for example, every day, and is sequentially suggested to the user. Accordingly, even when the user's behavior or preference do not change, the content of the recommended title abundantly change every day, so that the user's buying inclination improves. For example, in any one of the popular titles in the group of the users residing in the same region as that of the user of the recommendation object and the popular titles in the group of the user having similar behavior or preferences as those of the user of the recommendation object, the information is useful for the user of the recommendation object and the content thereof is different in many cases. According to the content recommendation device 102, the user's buying inclination for the content may be supported by switching the recommended information of the different content based on the different indexes every day and sequentially suggesting the switched recommended information to the user, and the user may be more stimulated to buy the content. Further, since the recommended content suggested to the user at a certain time point is based on a specific type of index, a part of the plurality of recommended content items may be prevented from being overlapped with each other.

Furthermore, when a plurality of types of recommended titles based on a plurality of types of indexes is switched every day and is suggested to the user, a recommended title based on a certain index A is suggested to the user, and the recommended title based on the index A is suggested again to the user after a predetermined period. Then, there is a possibility that the recommended title based on the index A changes in accordance with a change of the user's behavior or preferences during the period. In this manner, since the recommended title based on the same index also changes with the elapse of time, new recommended content may be easily suggested to the user every day.

Moreover, according to the content recommendation device 102, the content may be recommended in accordance with the business rule (the switching rule, the layout of the recommendation screen, and the sales target titles) decided by the regional manager. That is, even when the content recommendation plans are different depending on the nation or the region, the plan for each nation or each region may be flexibly handled. For example, even when a certain type of recommended title is suggested to the user, if the recommended title is normally designed by the regional manager, the normal recommended title is suggested to the user together with other recommended titles. Accordingly, the content sales plan for each nation or each region may be supported.

Further, according to the content recommendation device 102, the reproduced title of the user is appropriately excluded from the recommended title. Accordingly, the new title having a high possibility of being bought may be easily recommended to the user. Further, the recommended title to the user is appropriately excluded from the recommended titles. Accordingly, information not suggested to the user, that is, information not notified to the user may be easily provided.

As described above, the second embodiment of the present disclosure has been described. The embodiment is merely an example, and it should be understood by persons skilled in the art that the combination of the respective constituents or the respective processes may be modified in various forms and the modification examples thereof are also included in the scope of the present disclosure. Hereinafter, the modified examples will be described.

A first modified example will be described. Although there is no special remark in the second embodiment, a predetermined period is set as the switching interval of the regional switching rule. That is, a certain type of recommended title is selected by the selection section 148, and the same type of recommended title is selected again after the predetermined period through a different type of recommended title. At this time, it is desirable to set the predetermined period so that the predetermined period becomes the assumed period or more when the content of the above-described type of recommended title change. For example, when the first to eighth index recommended titles are sequentially switched and provided for the user, if the period until the first index recommended title changes is within eight days, the switching interval may be set to “one day”. Further, when the period is nine days or more, the switching interval may be set to “two days”. Accordingly, even when the same type of recommended titles are selected, the recommended content at a certain time point may be set to be different from the recommended content at the subsequent time point, so that the recommended content may be abundantly changed.

A second modified example will be described. Although there is no special remark in the second embodiment, it is desirable to set the normal recommended title and the recommended title dynamically decided by the recommended content deciding section 142 on the recommendation screen so that they are difficult to be distinguished from each other by their appearance (for example, they are displayed in the same display manner as it is seen from the outside). In other words, it is desirable to set the recommendation screen so that the normal recommended title of the sales promotion object is difficult to be distinguished from the plurality of recommended content suggested on the recommendation screen. Accordingly, the user may check the recommended information without any prejudice.

The arbitrary combination of the embodiments and the modified examples may also be usefully used as an embodiment of the present disclosure. The new embodiment obtained by the combination has the effects of the embodiments and modified examples combined with each other.

It should be understood by persons skilled in the art that the functions to be achieved by the constituents of the claims are realized by each of the constituents shown in the embodiments and the modified examples and the combination thereof.

The present disclosure contains subject matter related to that disclosed in Japanese Priority Patent Application JP 2010-131014 filed in the Japan Patent Office on Jun. 8, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A content recommendation device comprising:
a use information storage section which stores a plurality of types of information related to use as information related to use of content by a user;
a recommended content deciding section which decides content to be recommended to the user in accordance with each of the plurality of types of information related to use as a recommended content, and decides a plurality of types of recommended content items corresponding to the plurality of types of information related to use;
a switching rule storage section which stores a switching rule setting a period for switching the type of the recommended content as a rule set by a regional manager who is in charge of selling content in a specific region;
a selection section which selects one type of the recommended content among the plurality of types of recommended content items when a recommended content suggestion request is generated from a terminal of the user residing in the specific region, and sequentially selects different types of recommended content after the period set by the switching rule; and
a recommended information providing section which provides information representing the recommended content selected by the selection section for the terminal of the user.

2. The content recommendation device according to claim 1, wherein the plurality of types of information related to use includes information representing a popular content in a group of users having similar preferences and information representing a popular content in a group of users residing in the same region.

3. The content recommendation device according to claim 1, further comprising:
a sales promotion information storage section which stores information related to content as a sales promotion object set by the regional manager,
wherein the recommended information providing section provides information representing a plurality of content items to the terminal of the user, and at least one of the plurality of types of content includes the content of the sales promotion object.

4. The content recommendation device according to claim 1, further comprising:
a reproduced content information storage section which stores information representing content having been reproduced in the terminal of the user,
wherein the recommended content deciding section decides a recommended content except for the reproduced content.

5. The content recommendation device according to claim 1, further comprising:
a recommendation history storage section which stores information representing content having been recommended to the terminal of the user,
wherein the recommended content deciding section decides a recommended content except for the recommended content.

6. The content recommendation device according to claim 1, wherein the switching rule sets the period for switching the type of the recommended content so that a period from a timing of selecting one type of the recommended content among the plurality of types of recommended content items to a timing of selecting the one type of the recommended content again through a different type of the recommended content is equal to or more than a period in which the content of the one type of the recommended content is supposed to change.

7. A content recommendation method of allowing a computer to execute:
deciding a content to be recommended to a user in accordance with a plurality of types of information related to use which is information related to use of a content by the user as a recommended content and deciding a plurality of types of recommended content items corresponding to the plurality of types of information related to use;
selecting one type of the recommended content among the plurality of types of recommended content items when a recommended content suggestion request is generated from a terminal of a user residing at a specific region and sequentially selecting a different type of the recommended content after a period for switching the type of the recommended content set by a regional manager who is in charge of selling content in the specific region; and
providing information representing the recommended content selected in the selection of one type of the recommended content for the terminal of the user.

8. A computer program allowing a computer to implement the functions of:
deciding content to be recommended to a user in accordance with a plurality of types of information related to use which is information related to use of content by the user as a recommended content and deciding a plurality of types of recommended content items corresponding to the plurality of types of information related to use;
selecting one type of the recommended content among the plurality of types of recommended content items when a recommended content suggestion request is generated from a terminal of a user residing at a specific region and sequentially selecting a different type of the recommended content after a period for switching the type of the recommended content set by a regional manager who is in charge of selling content in the specific region; and
providing information representing the recommended content selected in the selecting of one type of the recommended content for the terminal of the user.
